(19) United States
(12) Patent Application Publication
(10) Pub. No.: US 2002/0165936 A1
(43) Pub. Date: Nov. 7, 2002

(54) Dynamically branded web sites

(76) Inventors: Victor Alston, San Mateo, CA (US); Eric Lo, San Mateo, CA (US); David Chow, San Mateo, CA (US)

Correspondence Address: David A. Hall, Heller Ehrman White & McAuliffe LLP, 7th Floor, 4350 La Jolla Village Drive, San Diego, CA, 92122-1246, US

(21) Appl. No.: 10/057,513

(22) Filed: Jan. 25, 2002

Related U.S. Application Data
(60) Provisional application No. 60/264,510, filed on Jan. 25, 2001.

(51) Int. Cl. G06F 15/16; G06F 17/60

(52) U.S. Cl. 709/217; 705/26

(57) ABSTRACT

A network facility provides a network-based Web site configuration and Web site processing facility comprising a network location at which subscribers define, create, and configure their Web sites to provide a hosted Web site, from which their Web pages will be dynamically generated and served to customers. The Web pages may be changed and previewed in real time from the subscriber's Web browser. Thereafter, the subscriber's Web pages may be viewed by Web site visitors. The hosted Web site provides a central e-commerce channel that contains a set of software applications and data that are used to dynamically generate the subscriber's Web site pages. The central e-commerce channel includes a process engine that handles the various services to be provided by the subscriber Web site.

### REFERENCE TO PRIORITY DOCUMENT

This application claims priority of co-pending U.S. Provisional Patent Application Serial No. 60/264,510 entitled “Dynamically Branded Web Sites” by V. Alston, E. Lo, and D. Chow, filed Jan. 25, 2001. Priority of the filing date of Jan. 25, 2001 is hereby claimed, and the disclosure of the Provisional Patent Application is hereby incorporated by reference.

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND OF THE INVENTION

1. Field of the Invention

This invention relates generally to processing at network nodes and, more particularly, to software applications deployed on a data network, such as on the Internet.

2. Background

The Internet is burgeoning, as evidenced by the number of sites on the “World Wide Web” and the number of users being added every day. The growth is especially impressive with respect to electronic commerce. Companies have found the Internet to be a great vehicle in enhancing business contacts, publishing company information, obtaining orders and customer feedback, and other aspects of e-commerce. In addition, companies are finding it necessary to have a presence on the Web to increase and even maintain their market share, and to enhance their businesses in general.

The effort to design and implement a competitive e-commerce Web site can easily takes months of work to more than one year, and many millions of dollars. One analyst has stated that it takes approximately thirteen to twenty-two months to build a competitive business site. See, for example, case studies described at the Web site of Internet Week Online magazine (at www.internetwk.com). Companies find that the ease with which they can deploy and maintain their Web sites have become critical factors in deciding on how to design and configure their Web sites.

One of the ways that companies have facilitated creating an Internet presence via a Web site is by hiring consultants with experience in deploying applications on the Web. The programming created by such Web consultants is highly customized and tailored to the company's particular business. The consultants typically provide the underlying e-commerce engine of the site by providing a set of object or code libraries, application programming interfaces (APIs), and the like. The hiring company may provide the front end, i.e., the graphical user interface (GUI) through which visitors to the Web site will access the company information. Such GUIs are usually highly customized to interface with the provided e-commerce engine. This solution may involve a substantial cost to the company, both for initial design and development and for continuing site maintenance. Furthermore, it involves always ensuring that the front-end is tightly integrated with the underlying engine for the site to work properly. Thus, changes in the front-end GUI or the underlying back-end or engine code may result in problems and an unsatisfactory user experience. If Web consultants provide both the e-commerce back-end and the GUI front-end code or libraries, the time to deploy such applications generally is not significantly reduced, but still involves a substantial amount of time, as stated above.

Another issue that companies also consider is whether to host the Web site with their own equipment or to outsource the Web site hosting. If a company, for example, desires a 24×7 (24-hours per day, seven days per week) site availability, then the company must obtain sufficient computing and information technology (IT) resources to ensure that the Web site is up within the prescribed period and is properly maintained thereafter.

There are “build-your-own” Web sites currently available that enable companies to create their own Web sites. Such Web sites may offer graphical elements, background processing, and other facilities to implement Web site processing. Typically, the skill set required to create a Web site that offers more than a static experience and provides an effective presentation will include knowledge and experience in a scripting language, a markup language, and a high-level programming language. Examples of scripting languages include “JavaScript” (developed by Netscape Communications Corp. of Mountain View, Calif., USA), “Active X” Script (developed by Microsoft Corporation of Redmond, Wash., USA), Visual Basic (VB) script, PERL, the “Cold Fusion” product by Allaire Corporation of Cambridge, Mass., USA, and the like. Typical markup languages used for Web programming include HTML (hypertext mark-up language), XML (Extensible Markup Language), WML (wireless markup language), XSL (Extensible Style Language), and the like. The high-level programming languages include C, Java, C++, Visual Basic, and the like. All of these resources are readily available and will be familiar to those skilled in the art.

Such build-your-own Web sites provide information through a GUI, which guides a company on how to create an e-commerce Web site by producing their own collection of Web pages. Company users may add simple page elements, such as images, text, buttons, banner ads, list boxes, forms, and the like. Users of such Web sites may also be directed to particular portions of a Web page, which may be customized in a limited manner. For example, users can place their own customized pictures, text, and the like by using appropriate HTML Web editing commands. How each Web site page should relate to other pages and how it should be linked to subsequently added Web pages are hard-coded into each Web site page, such as by specifying the subsequent page through a hyperlink, thereby providing a direct path from the first page to the subsequent. Each Web site page, based on the information provided by the user, is generated as an HTML file and then is physically stored as data. The data files comprising the company's Web site are then typically hosted and stored by these build-your-own Web sites. Thus, Internet users who request such pages will produce requests for the data files from the build-your-own site, resulting in the stored HTML files being served by Web server software at the site.

The Web sites created using the tools available on build-your-own Web sites are usually relatively simple, with limited features and capabilities. A company that sells, for example, customized machinery or complex products will not likely be able to use the tools found at a build-your-own Web site to create a competitive and effective e-commerce site. Furthermore, sophisticated e-commerce transactions such as requests for quotes, recommendations for alternative parts for a custom order, orders for complex products, and the like, cannot be supported with the readily available Web site tools.

Many software applications are deployed in mainframe computer systems, network Personal Computer (PC) systems, or stand-alone systems (herein referred to as state-oriented systems) that are not Internet-based. That is, such applications are not designed to be executed from a Web server computer. Applications deployed on state-oriented systems maintain state, which means that the software applications are written and executed so as to monitor and remember information, such as relevant memory variables, as the application user traverses from one window, display, graphical user interface, or page to another. For example, the application may remember what the user was last doing, what windows or displays were last viewed and/or responded to, the user identification, memory variables in previous displays or windows, user entries, and the like.

Unlike software applications deployed on state-oriented systems, the Internet is intrinsically stateless, because each request for a page from a Web server is processed without any knowledge of the pages previously requested, who the current requesting user is, the relevant information stored in the previous pages, and the like. To be efficient and useful, Internet-deployed software applications, similar to those deployed on state-oriented systems, need to keep track of the state of the applications. For example, an Internet-deployed shopping cart system, to be useful, must establish a “session” to allow the software developer to store information in memory variables to monitor which pages the user has viewed, which items have been selected for purchase, the quantity ordered, customer billing information, shipping information, and the like. Because information needed to finalize a Web sales transaction typically are presented by a site visitor over various Web pages, a way to monitor state information or variables within such software application is important. This typically involves monitoring the pages visited by a user. A way to enforce this flow of pages and a way to keep track of the state of an application, thus are needed to be able to deploy effective sites, particularly commerce sites, on the Internet.

From the discussion above, it is apparent that there is a need for enabling companies to easily develop a presence on the Internet with little or no programming expertise and/or resources required. It would be advantageous to permit companies with sophisticated requirements to easily and expeditiously customize and configure their Web sites. The present invention fulfills these needs and the shortcomings described above.

### SUMMARY OF THE INVENTION

In accordance with the invention, a subscriber network site may be defined, created, and configured on-line through a network host facility. The network host facility provides a network-based Web site configuration and Web site processing facility comprising a network location at which subscribers define, create, and configure their Web sites to provide a hosted Web site from which their Web pages will be dynamically generated and served to customers. The subscriber may change and preview the subscriber's Web pages in real time from a conventional Web browser. The subscriber's hosted Web site provides a central e-commerce channel that contains a set of software applications and data that are used to dynamically generate the subscriber's Web site pages. The central e-commerce channel includes a process engine that handles the various services to be provided by the subscriber Web site. In this way, the network host facility enables companies to easily develop a network presence, such as by implementing an Internet Web site, with little or no programming expertise and/or resources required, thereby permitting companies with sophisticated requirements to easily and expeditiously customize and configure their Web sites.

The Web site services supported by the network hosting facility may include, for example, order entry, request for proposals and/or quotes, purchase order, inventory scheduling, and the like. Because the underlying Web site services are defined by the process engine, to quickly define and configure a Web site, subscribers need only define their branding information, i.e., how they want their Web site to look and feel, and how they want to configure their site. The configuration information typically includes selection and configuration of appropriate site offerings, for example, by defining the offerings and corresponding attributes, recommendations, constraints, rules, logic, and the like. A set of graphical user interfaces, such as a Web site for the hosting facility, is provided to the subscribers to let them easily define their branding and configuration information. In this way, subscribers can easily create and deploy their Web sites, usually in a matter of weeks; any new business services and even business features implemented or incorporated in the process engine are immediately available to subscribers for their use. The process engine can serve more than one subscriber, using the same underlying processing.

Other features and advantages of the present invention should be apparent from the following description of the preferred embodiment, which illustrates, by way of example, the principles of the invention.

### BRIEF DESCRIPTION OF THE DRAWINGS

FIG. 1 is a block diagram of an e-commerce system constructed in accordance with the present invention to provide a dynamically branded subscriber network site.

FIGS. 2 and 3 are embodiments of exemplary user interfaces constructed in accordance with the present invention that enable a subscriber to enter subscriber branding information for the subscriber network site.

FIGS. 4a-4c are exemplary predefined page templates within a section, e.g., to list models within a product line, for the subscriber network site.

FIG. 5 is an exemplary user interface constructed in accordance with the present invention, listing supported segments of a particular subscriber.

FIG. 6 is an exemplary user interface constructed in accordance with the present invention, listing product lines available within a supported segment.

FIG. 7 is an exemplary user interface constructed in accordance with the present invention, enabling a subscriber to enter detail information about a particular product line.

FIG. 8 is an exemplary user interface constructed in accordance with the present invention, enabling a subscriber to enter detail information about a particular model.

FIGS. 9a and 9b are exemplary user interfaces constructed in accordance with the present invention, enabling a subscriber to enter and define configurable and custom attributes.

FIG. 10 is an exemplary user interface constructed in accordance with the present invention, enabling a subscriber to define a condition-action set, in particular, a constraint.

FIG. 11 is an exemplary user interface constructed in accordance with the present invention, informing a subscriber of the available elements that may be used to define a function.

FIG. 12 is a basic block diagram of how a subscriber creates a Web site in accordance with the present invention.

FIG. 13 is a basic block diagram of how a user accesses a subscriber's Web site in accordance with the present invention.

FIG. 14 is a basic block diagram of one embodiment of how the features of the present invention may be implemented.

FIG. 15 (comprising FIG. 15a-15q) lists an exemplary HTML file created by the e-commerce system in accordance with the present invention.

FIG. 16 is an exemplary user interface constructed in accordance with the present invention, enabling a user to search, place a direct buy, submit a request for a proposal, and the like from a subscriber's site.

FIG. 17 illustrates a block diagram representation of one of the computers in the e-commerce system illustrated in FIG. 1.

### DETAILED DESCRIPTION

The following detailed description illustrates the invention by way of example, not by way of limitation of the principles of the invention. This description will clearly enable one skilled in the art to make and use the invention, and describes several embodiments, adaptations, variations, alternatives, and uses of the invention, including what we presently believe is the best mode of carrying out the invention.

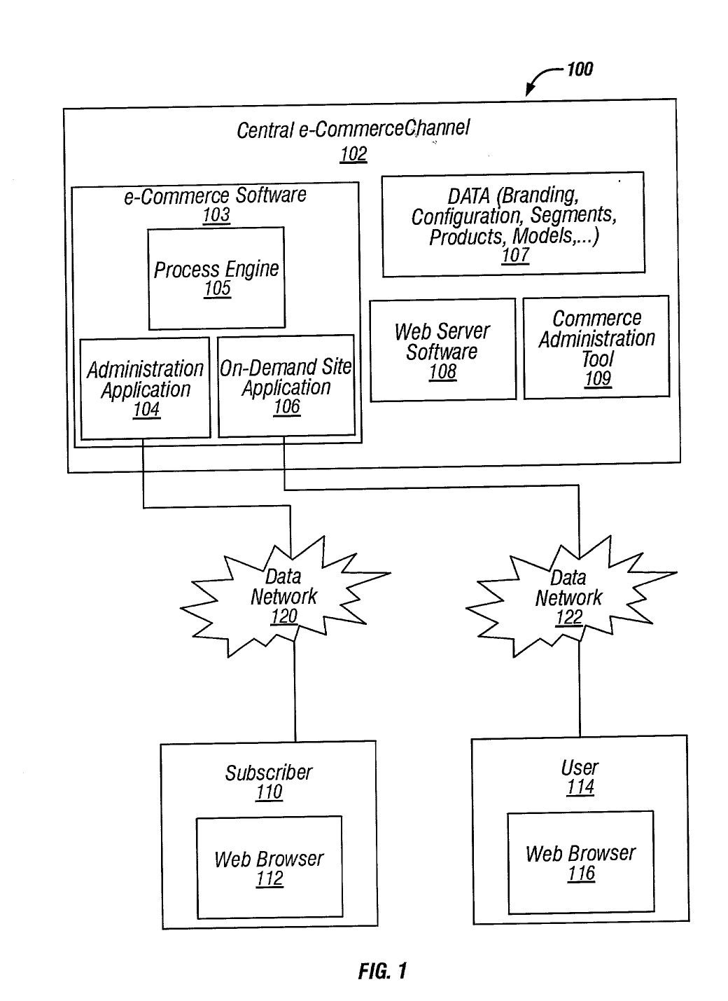

FIG. 1 illustrates a block diagram of an e-commerce system 100 constructed in accordance with the present invention. The e-commerce system 100 enables the on-line definition, creation, and configuration of a subscriber network site through a network host facility and supports e-commerce processing of the subscriber network site. The network host facility comprises a network location that provides a hosted network site from which pages of a subscriber's network site will be dynamically generated and served to customers. The subscriber may change and preview the subscriber's pages in real time from a conventional browser program.

The network host facility provides a central e-commerce channel 102 comprising a hosted network site (e.g., an Internet Web site) that contains a set of software applications and data that are used to dynamically generate the subscriber's pages. Thus, the subscriber's network site is not statically stored at a network location, but rather each page of the subscriber site is generated in real-time, in response to a request for a particular page. This scheme enables companies to easily develop a network presence with little or no programming expertise and/or resources, and it permits companies with sophisticated requirements to easily and expeditiously customize and configure their sites.

The central e-commerce channel 102 is connected to one or more subscribers 110 via a data network 120, which may include a local area network, a wide area network, a wireless network, a value-added network, the Internet, an Intranet, and the like. A subscriber 110 is typically a company or a business that enters into a subscription for business services with the provider of the e-commerce channel 102 to enable customers 114, such as users on the Internet, to obtain information about the subscriber. More particularly, the customers may place orders, request information about the subscriber's products and services, request proposals and quotes, and make other inquires and transactions to the subscriber company. The central e-commerce channel 102 is also connected to one or more users 114 via a data network 122. Users 114 are those entities or individuals who are interested in accessing the pages of a subscriber's site. Both data networks 120 and 122 may be the same network, such as the Internet, in which case the subscriber's network site is generally referred to as a Web site.

Contained in the central e-commerce channel 102 is a set of software applications. These applications may include, for example, an administration application 104, process engine 105, and on-demand site application 106, which will be collectively referenced as e-commerce software 103. The central e-commerce channel 102 also contains Web server software 108 and a commerce administration tool 109. Examples of Web server software, which will be familiar to those skilled in the art, include “INTERNET INFORMATION SERVER” by Microsoft Corporation and “Apache” server software. Data 107, such as information on the subscriber company, segments, products, and the like are also stored in the central e-commerce channel 102.

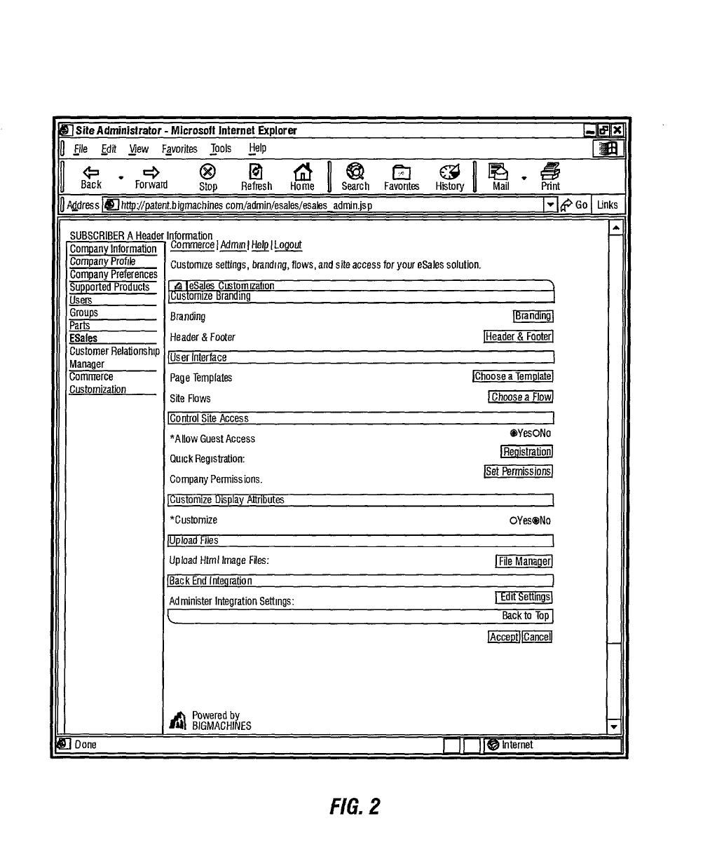

A subscriber 110 communicates with the central e-commerce channel 102 via a software application, such as a Web browser 112. Examples of Web browser programs include “Internet Explorer” from Microsoft Corporation and “Navigator” from Netscape Communications Corporation. A subscriber 110 may create a Web site by accessing the administration application 104 of the central e-commerce channel 102. The administration application 104 in one embodiment is a Web-based application that provides a Web interface for specifying the subscriber's Web site pages. Subscriber inputs, such as branding information and configuration information, are received by the administration application 104 from the subscriber and are stored as data 107 in the central e-commerce channel 102. Typically, subscribers enter their inputs by simply selecting from among options on the GUI, for example, by selecting segments from a list box of the GUI, and by entering appropriate information or data in input boxes. FIGS. 2 to 11 illustrate exemplary GUIs, with which a subscriber interacts to create the subscriber's Web site. By going through the administration process (e.g., branding and segment configuration) via the administration application 104, a subscriber creates a customized site. Subscribers do not necessarily have to program complex codes, such as scripting codes, to create and deploy a customized site on the Internet.

More particularly, a subscriber 110 submits branding information to specify company name, logo, trademarks, and the like, to establish a unique “look and feel” to the subscriber's Web site. For example, branding information may include company profile information comprising a text description, as well as trademarks and designs to identify the company, and color, font, and size specifications for the information. The configuration information may include specifying the company's market segment, product lines, and configurable models. Thus, the network facility may support multiple market segments, and each segment may comprise multiple product lines and configurable models. For example, one market segment might be the sale of industrial pumps and valves, such as for manufacturing facilities or water distribution systems or water treatment plants. Another market segment might be for the sale of motor vehicles such as automobiles. A subscriber may want to establish, for example, a Web site in the automotive segment. The subscriber may handle multiple product lines, such as Audi, BMW, and Chrysler for example, or perhaps the subscriber may handle only a single line of automobiles. For each product line handled by a subscriber, the subscriber will need to specify the configurable models being offered, such as 300-series, 500-series, and 700-series models for BMW.

After a subscriber 110 has provided branding information and configuration information to the host facility, network users 114 may request pages of the subscriber's site, thereby “visiting” the subscriber's site. Thus, the network users comprise customers of the subscriber Web site. A user 114 communicates with the central e-commerce channel 102 via a software application, such as a browser 116. A network user, such as a customer, buyer, supplier, vendor, and the like, accesses a subscriber site via the on-demand site application 106 contained and hosted by the central e-commerce channel 102. In one embodiment of the invention, assuming for the sake of example that the Web site for the central e-commerce channel 102 has the domain name “http://www.cec102.com,” then a user 114 accesses the site of Subscriber A by specifying “http://subscriberA.cec102.com” as the uniform resource locator (URL) in the user's browser. Typing in “http://subscriberB.cec102.com,” on the other hand, for example, accesses Subscriber B's network site. Variations on how users access Web sites, such as through hyperlinks, redirections, and the like, are known to those skilled in the art.

Using the e-commerce software 103, the central e-commerce channel 102 supports a number of subscribers, from various industries or lines of business, using the same e-commerce software 103. The e-commerce software 103 is stored, maintained, processed, and executed in the central e-commerce channel 102. The central e-commerce channel 102 thus provides a fully hosted solution for subscribers, thereby alleviating the subscriber's burden of site maintenance. Thus, issues such as data replication, data backup, recovery from system crashes, and the like are handled by the provider of the central e-commerce channel 102 rather than by each individual subscriber 110. Subscribers typically use the e-commerce system 100 as a “procurement hub” to handle and process purchases, requests for proposals, purchase orders, and the like. Thus, a subscriber may have a corporate Web site at a corporate domain URL, with a link to the central e-commerce channel 102 that will direct customers to the e-commerce channel site 102 when customer orders, for example, need to be processed.

The administration application 104 is the application used by subscribers 110 to configure and create their custom network sites. The on-demand site application 106, on the other hand, receives requests for Web pages from network users (customers) and in response dynamically generates the appropriate subscriber's Web page on-demand, i.e., when the request is received. Thus, subscriber Web pages are not stored in the data store of the central e-commerce channel 102. To create a customized Web site, a subscriber accesses the administration application 104 and goes through the branding process and configuration process (collectively called the administration process).

The process engine 105 of the e-commerce channel 102 is a set of software applications (or an underlying application engine) that uses the branding information and the configuration information, and other appropriate data 107 stored in the central e-commerce channel, to handle a business service provided by the e-commerce system 100. The process engine 105 contains logic and rules on how certain business services (e.g., order entry, requests for proposal (RFP), purchase orders, and the like) should be processed. For example, using the branding information and configuration information defined via the administration application 104, the process engine runs the underlying engine or logic to process orders, for example, stores the order record into the appropriate database, updates the counts available, checks to determine if there are sufficient stocks on hand, and the like. Depending on the services provided by the central e-commerce channel 102, the process engine 105 may have various additional capabilities and features. The process engine 105 may be integrated with the on-demand site application 106.

Because the central e-commerce channel 102 provides the underlying service engine (e.g., to process orders), any new business service implemented in the process engine 105 may be quickly made available to all subscribers through appropriate selections by subscribers through the administration process. Subscribers who want to avail themselves of new services need only specify how to brand their Web site and configure their supported segments (further discussed below) to include the processing. The e-commerce software 103 being executed in the e-commerce channel 102 is the same for all subscribers and users. This makes the central e-commerce channel 102 scalable, and thus makes deploying custom sites for various subscribers more easily achieved.

To implement a new business service, such as order entry, a set of order entry code or programming logic is added as part of the process engine 105. The data structures of existing segments, including their data types and the like, will be considered, to minimize unnecessary modification or addition of information by the subscriber. For example, if the central e-commerce channel 102 only provides one business function, such as RFP processing, and if it is desired to implement order entry, then the process engine 105 would be updated to include order entry logic. If there are no changes in the branding information and/or configuration information for a subscriber, then that subscriber may select order entry as part of its subscribed service and have order entry and RFP immediately available to users. Any other additional changes, such as branding or product information, may be changed during the same session. All changes will immediately be available to customers. In this way, modifications to the process engine 105 are immediately available to subscribers and, after site modification by subscribers, to the customers of subscribers.

If a new line of industry (e.g., a new market segment) is created by the provider of the central e-commerce channel 102, then a subscriber need only select and configure the newly created segment. Preferably, the provider of the network facility provides different arrangements or hierarchies of Web pages for different segments, in accordance with the different needs that might be important to the different segments, so that selecting a market segment determines a set of linked Web pages, thereby configuring the subscriber's Web site. But once the subscriber's segment is configured, the subscriber may immediately use the existing business services already available in the process engine. Furthermore, the latest modifications to the e-commerce software, in general, are immediately available to subscribers and users.

The commerce administration tool 109 will be further discussed below.

I. Branding Process

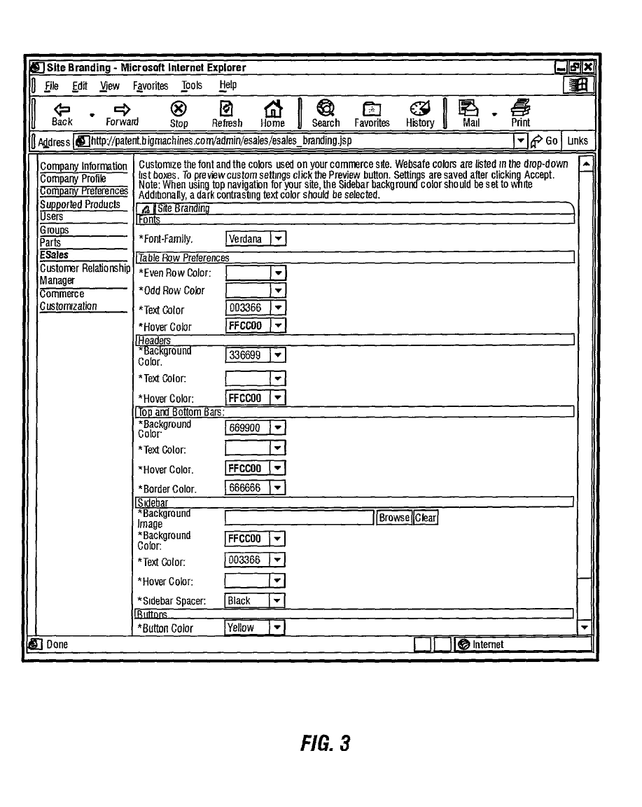

FIGS. 2 and 3 are embodiments of exemplary user interfaces that enable a subscriber to “brand” its own site. Branding involves defining subscriber's information such that the Web site created for that subscriber has the “brand” or “look and feel” that the subscriber desires, i.e., it is customized for that particular subscriber. In one embodiment, subscribers may preview the customizations or branding they have defined during the branding process.

A. Cascading Style Sheet

The administration application 104 provides a GUI to enable a subscriber to define custom header and footer information (e.g., by custom HTML). The subscriber may also define desired font styles, colors (e.g., background, text, highlight, hover, border, etc.), images, sound clips, video clips, button styles, and the like (see FIG. 3). In the illustrated embodiment, the branding information is defined by the subscriber and is stored in a cascading style sheet (CSS) file, which is referenced and used by the host network facility 102 for generating all the Web pages associated with a particular subscriber. At any time, subscribers who wish to change their branding information may do so on-line and in real-time by accessing the administration application 104 and saving the appropriate changes. The CSS scheme is a simple styling language that enables elements, e.g., HTML elements, to have an associated style, such as unique position, color, font, and the like. A style sheet is a template, very similar to templates in desktop publishing applications, containing a collection of rules declared to various elements. Using the GUI presented, as shown, for example in FIGS. 2 and 3, each subscriber 110 may define its own CSS.

B. Flow

Subscribers may also customize the flow of their sites. A site flow refers to the set of Web pages and their order and sequence, in a Web site. The site flow also includes how the pages interact and relate with each other (i.e., linking). In the illustrated embodiment of the invention, each subscriber 110 may define its own Web site flow. The e-commerce channel 102 simplifies this definition process through the administration application 104, which provides a list of predefined flows from which subscribers may choose. For example, if a subscriber sells only one product line, the subscriber may opt to skip the page showing all the different product lines. On the other hand, if a subscriber has a number of product lines, the subscriber may desire to include a page showing a listing of all product lines. In one embodiment, all Web pages start with a home page, e.g., company profile page. In terms of the automotive example provided above, a retail automotive dealer who handles products from only one automobile manufacturer may decide not to use any predefined flows that show multiple product lines, but a dealer who handles many different makes of automobile may decide to use a predefined site flow that lets the subscriber define each of multiple product lines.

Each site flow definition, as selected by a subscriber, enables the e-commerce channel 102 to maintain and determine the state of the Web page currently being presented to a user. This is important in ensuring that a customer may move from page to page in a subscriber's Web site without fear of loosing transactional information. For example, certain state information concerning a customer's session (such as shopping basket information and product searches) must be preserved as the customer visits pages. The different predefined flows from which a subscriber makes selections must be programmed such that customer session state information is available for needed e-commerce processing regardless of the route used by the customer to arrive at a processing page.

For example, one predefined flow may comprise a five-page flow from Page “A” to Page “B” to Page “C” to Page “D” and then to Page “E”. This first predefined flow may be selected by Subscriber A. Another predefined flow might comprise a three-page flow from Page “B” to Page “D” to Page “E”. This second predefined flow might be selected by Subscriber B. If Page “E” is a purchase page, then all customers who arrive there must have whatever information is needed for Page “E”, even though customers who visited the Subscriber B Web site will necessarily not have state information that might otherwise be picked up upon visiting Page “A” and Page “C”, if they had visited Subscriber A's Web site.

In accordance with the illustrated embodiment of the invention, the processing of the central e-commerce channel 102 ensures that the necessary state information is communicated regardless of the site page flow selected by a subscriber. This means, for example, that if a user customer selects the “cancel” button from a currently presented page for a given predefined site flow, then the central e-commerce channel 102 already knows which previous pages, as well as any other relevant information, have to be dynamically generated on-demand based on that cancel request, and knows which page of the site to which it should return.

C. Predefined Page Templates

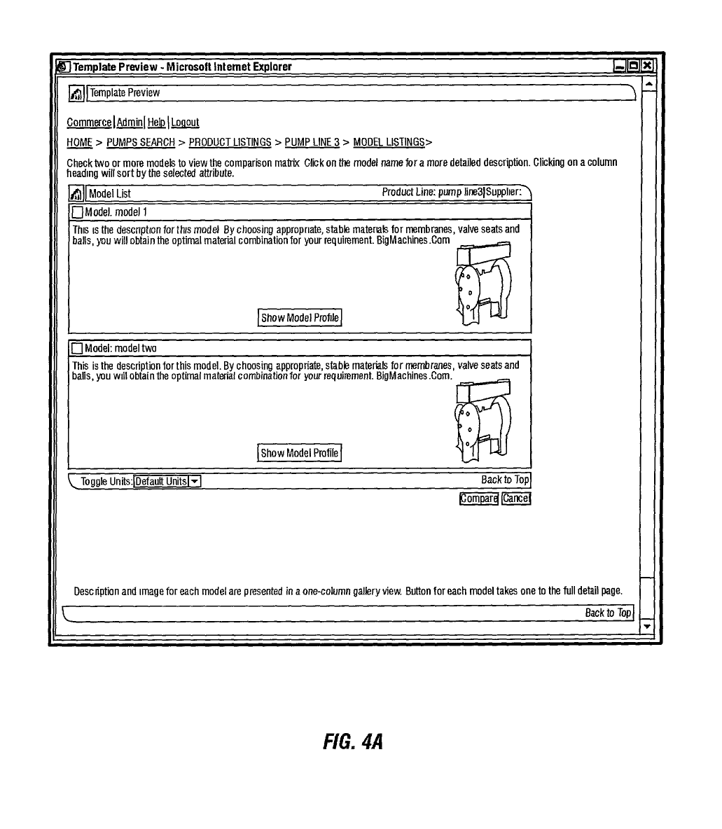

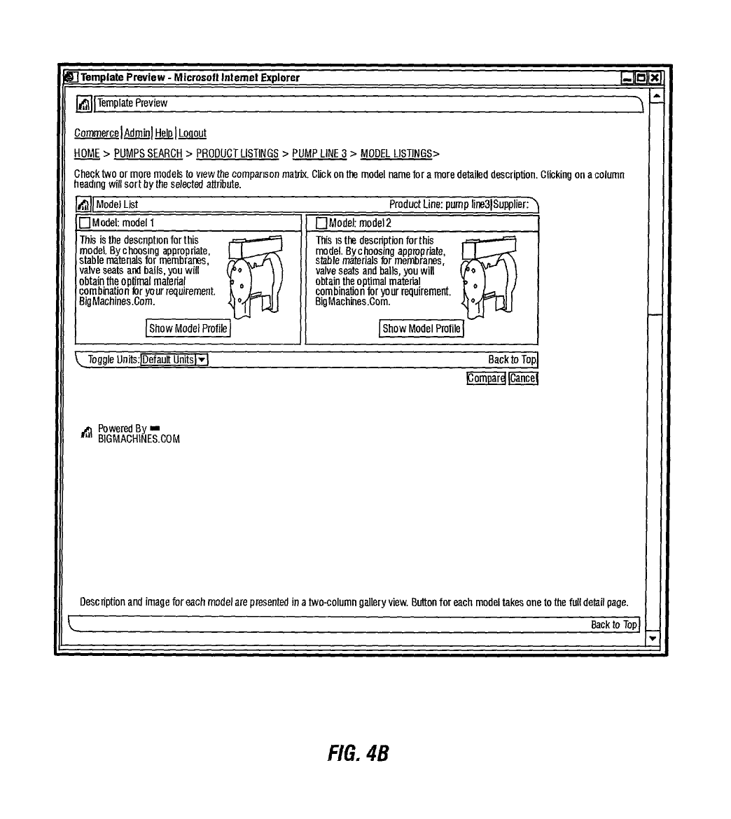

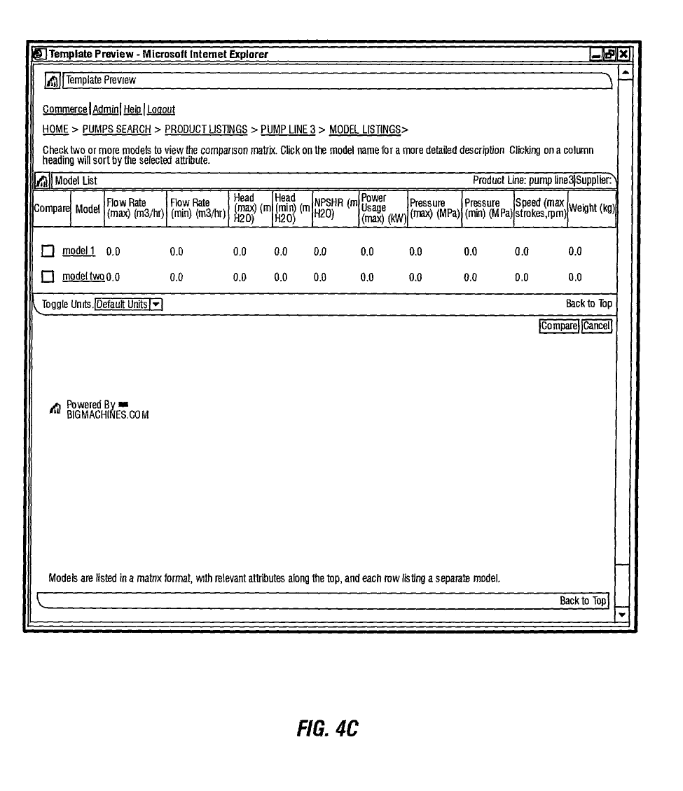

In one embodiment of the invention, subscribers are presented with a list of predefined page templates from which subscribers may choose to customize their Web sites. FIGS. 4a-4c illustrate exemplary predefined page templates that enable a subscriber to list models within a product line. This provides subscribers with added customization capability.

In one embodiment, each predefined page template is a Java Server Page (JSP) file. Each JSP file or predefined page template within a section, e.g., the list model section, is specified by subscribers by their providing the same input and output parameters.

D. Other Customizable Features

Other aspects of the subscriber's Web site may also be customized. For example, the subscriber may customize security, guest access, and the like by using the administration application 104, as exemplified in FIG. 2. Custom images, video clips, sound clips, segment information, part information, database information, and the like may also be uploaded to and stored in the central e-commerce channel 102.

Subscribers may also customize back-end integration, i.e., integration of various business services, such as integrating the RFQ function with the Quote service, integrating the Purchase Order service with the Direct Buy Purchase Order service, and the like.

Once a subscriber brands its own site by accepting and saving the changes and additions to the templates, such as clicking on the “Accept” button as shown in FIG. 2, the branding information is stored at the network facility. In one embodiment, this information is stored in various text files, such as header, footer, initialization, and CSS files. Alternatively, such information may be stored in a relational database management system (RDBMS) such as SYBASE, MICROSOFT SQL SERVER, and the like according to their respective file formats. Subscribers have their own branding information, as well as configuration information.

As shown in FIGS. 2 and 3, and other subsequent figures, the branding information are implemented by the subscriber merely by selecting options from the GUI and providing some information via data entry. Moreover, very minimal or no programming is required by the subscriber to provide this information.

II. Segment Configuration Process

In enabling various industries to use the same e-commerce software 103 to create customized sites, a number of segments are defined within the e-commerce software 103 from which subscribers may select. Segments are a general category of products and/or services, for example: pumps, valves, mechanical seals, mixers, heavy mixers, air compressors, gas compressors, air filters, filter bags, filter cartridges, filter bag housings, vacuum pumps, vacation, electronic forms, finance and insurance, automobiles, transmissions, semiconductor, plastics, welding, hydraulics, and the like. Each segment consists of one or more product lines, with each product line further broken down by models.

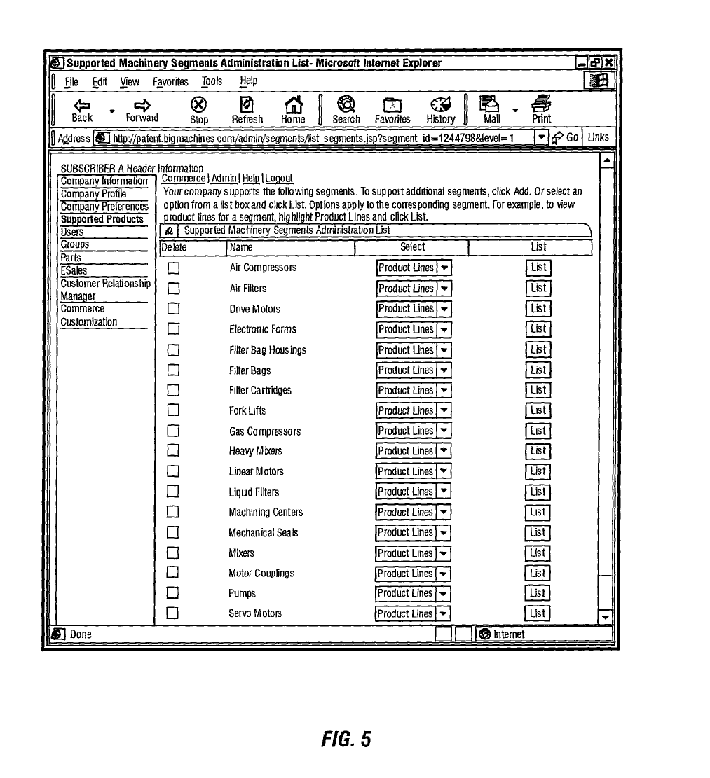

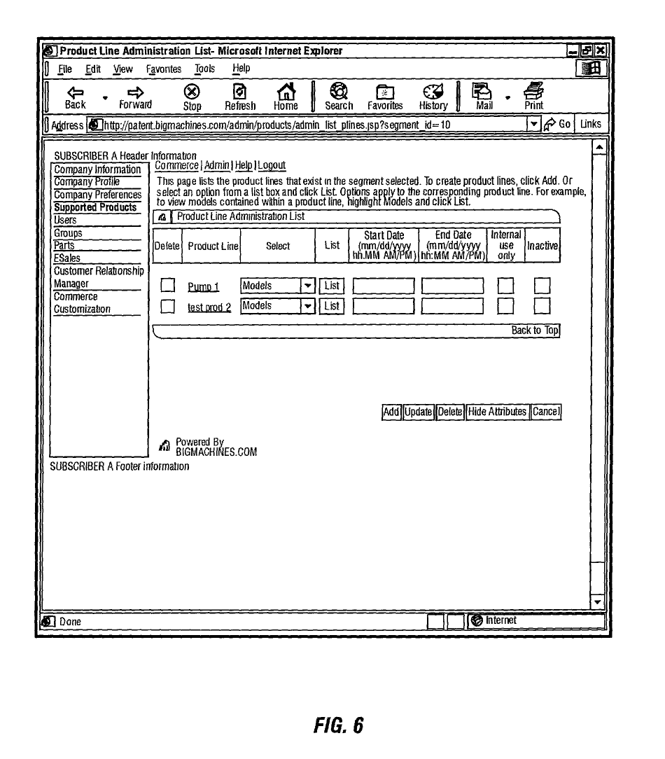

FIG. 5, for example, illustrates a sample GUI “Segment Administration List” page that illustrates segments that may be selected by a particular subscriber. The list of various segments, such as Air Compressors, Air Filters, Drive Motors, and the like, is a list of product lines supported by the site flows and templates provided by the provider of the network facility. Selecting the “List” button to the right of each segment product line, for example, brings up another page, e.g., the Product Line Administration List page shown in FIG. 6. The FIG. 6 administration page list provides a list of supported product lines and enables the subscriber to create and update the available product lines for each particular segment.

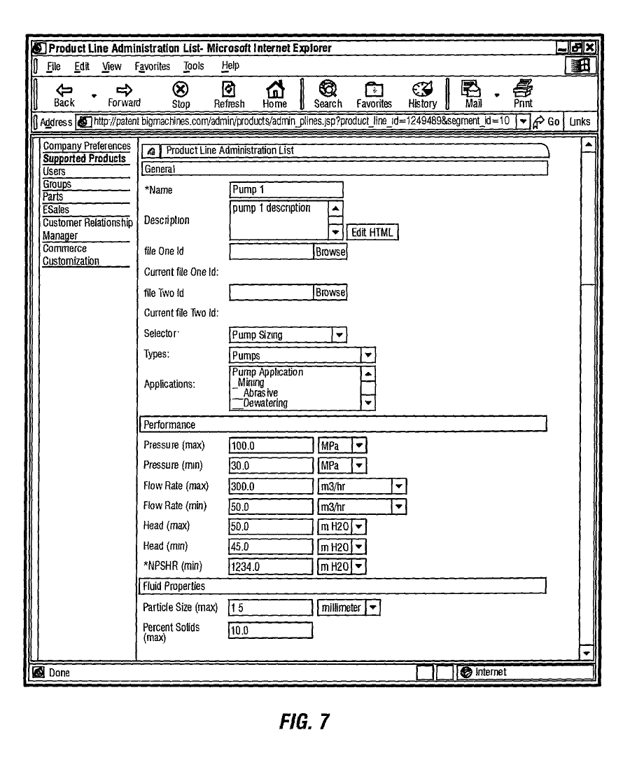

Generally, a market segment, including the underlying product lines and configurable models, is described by a general set of information at the product level. The provider of the network facility and e-commerce channel generates the product data fields to receive information from the subscriber to sufficiently describe the segment for which the subscriber supplies products. Pumps, for example, have the general characteristics or fields as shown in the Product Line Administration page of FIG. 7, wherein they are defined according to name, identification, type, application, and the like. Corresponding characteristics or fields for an automotive market segment, for example, may include product lines for different automobiles (analogous to pumps, filters, motors, and the like), such as 300-Series products, 500-Series products, and 700-Series products in the case of BMW automobiles.

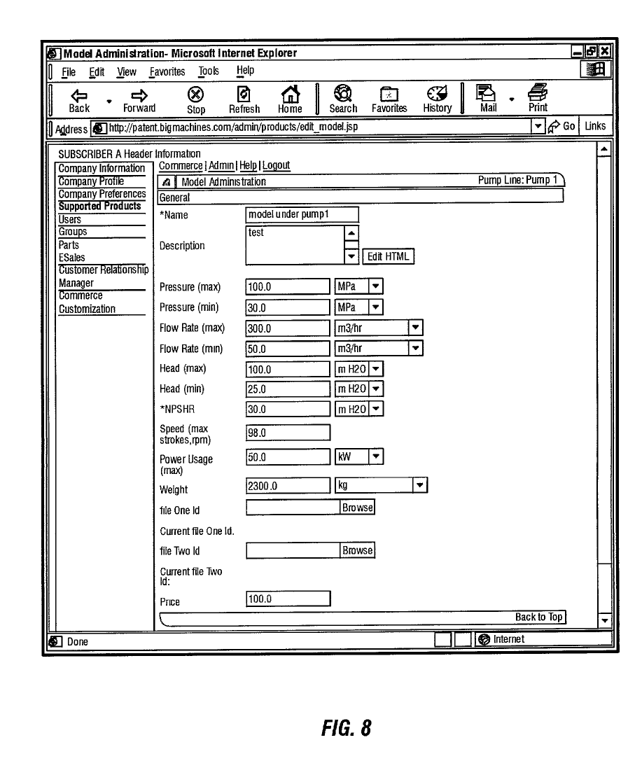

Additional characteristics or fields may be further defined during the definition of a configurable model, such as shown in the Model Administration page illustrated in FIG. 8. This page illustrates additional fields for the model, “model under pump 1,” which is part of the “Pump 1” product line shown in FIG. 7. In the case of the automotive example, such additional fields for configurable attributes of a model might include a particular model configuration such as two doors or four doors, the engine size (four cylinders, six cylinders, or eight cylinders), transmission (automatic shift, manual shift), or trim level, and other model configuration details. Again, the fields are defined by the provider of the network facility and e-commerce channel, based on knowledge of the market segment, product lines, and configurable models that will be supplied by subscribers of the site hosting service.

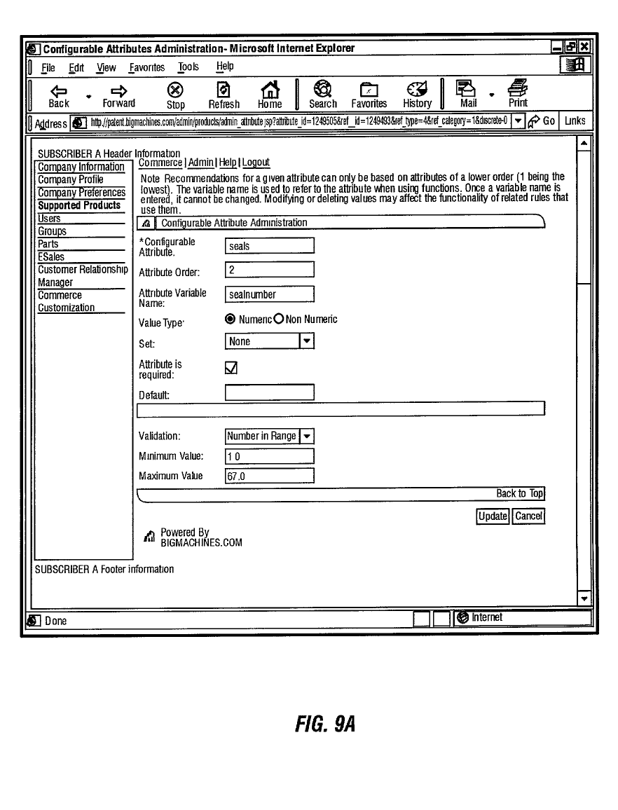

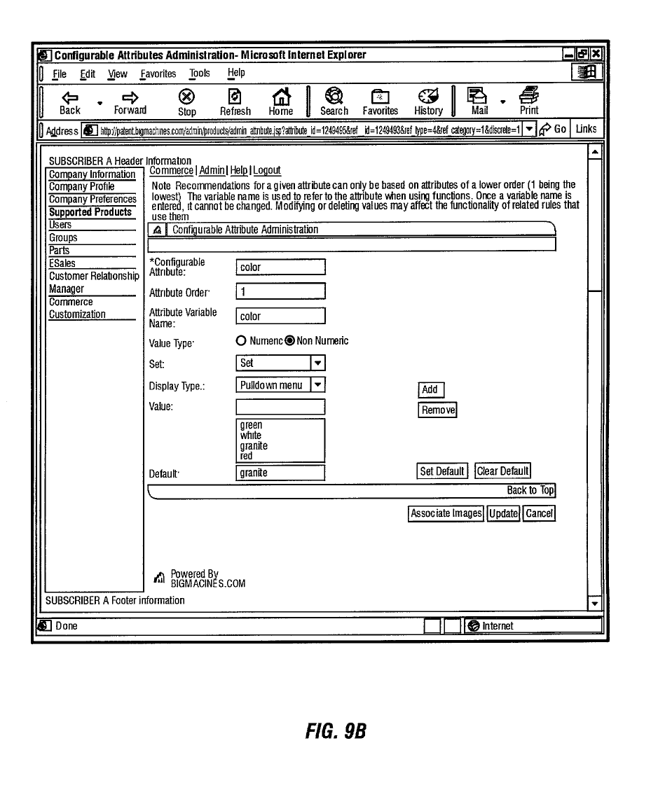

Within each configurable model, attributes specific to that model may be further defined, as shown in the Configurable Attribute Administration pages illustrated in FIGS. 9a and 9b, via the administration application 104. Similarly, rules, constraints, and default values may be defined to limit the configuration combinations that may be selected and searched by customers. Each attribute may be ranked (an “attribute order”), as desired by the subscriber. In one embodiment, the attribute with the lowest number (e.g., 1) takes precedence over other attributes.

Additional rules, constraints, and recommendations may also be defined. They are typically defined as a condition-action set. Functions may be used to define the condition and/or action.

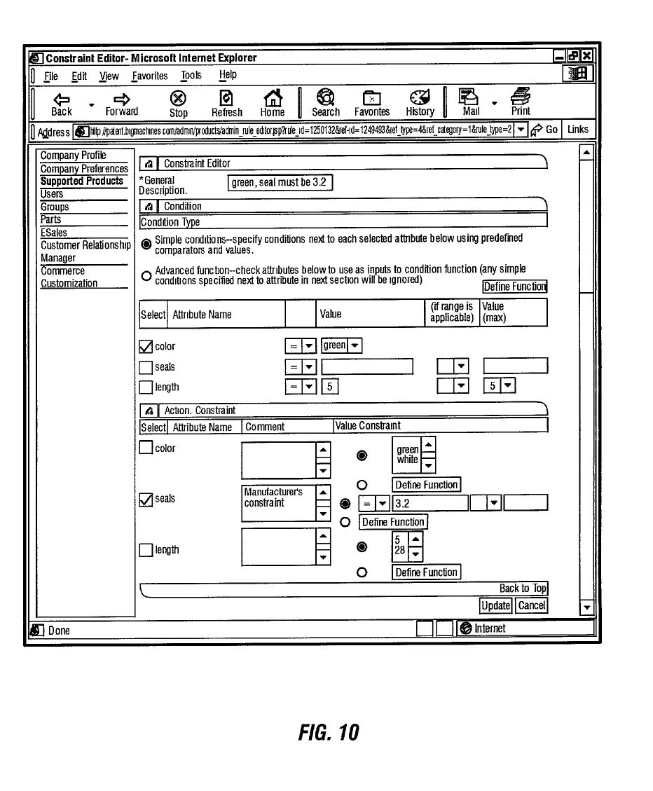

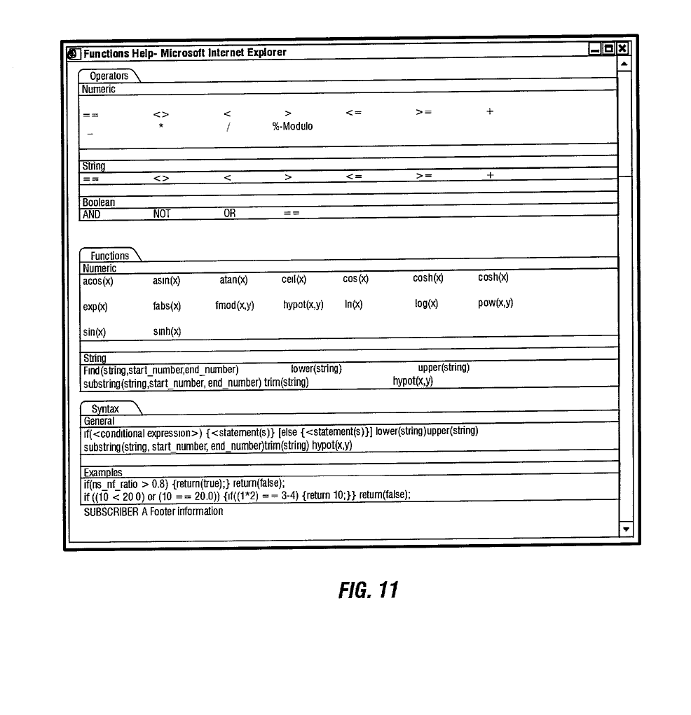

A configurable model within a product line may have restrictions or constraints based on certain subscriber-supplied rules. Referring to the Constraint Editor page illustrated in FIG. 10, for example, if a certain model has three attributes, e.g., color, seals, and length, then a subscriber may define a constraint by specifying the action, i.e., the constraint. As shown, if the color is green, the seal must be 3.2 inches. In the automotive context, a similar constraint may be implemented where it is desired, for example, to always supply models of a certain engine size (such as eight cylinders) with a mandatory transmission selection (such as automatic shift).

Functions may be defined using one or more attributes. A GUI, such as a function editor, may be used by the subscriber to enter the desired functions. The functions (including syntax) are accordingly parsed, validated, and saved. A help editor, for example, as shown in FIG. 11, is available if subscribers need assistance. For example, one important constraint for a mixer is that it should not be operated near the natural frequency, because this causes the amplitude of the vibration to increase until the mixer breaks apart. In order to check for this constraint, a set of functions has to be defined. One function to be defined calculates the natural frequency (NF). Using the shaft, length, shaft diameter, and impeller mass attributes, the function NF is defined, i.e., NF=shaft length * (shaft diameter+3.2)/impeller mass). The second function to be defined calculates the system frequency (SF) from other attributes (SF=Square Root (motor speed) * (fluid % tank size)). The third function calculates the ratio of NF over SF (SF/NF). If the ratio is greater than 0.8, a message is displayed advising the user that there is a problem and advising which attributes may be adjusted to find an acceptable solution.

In one embodiment, condition-action sets are saved as JAVA classes and run dynamically, if necessary. This makes these condition-action sets immediately available for use.

Recommendations may also be defined, as a condition-action set. For example, a subscriber may define that if the color of the model is white and the seal is 3.3, the recommended length is 23, 59, or 100 inches long. Recommendations may also be ranked, such as first recommended value, second recommended value, and the like.

Bill of materials (BOM) may also be defined as a condition-action set. For example, by defining the appropriate condition, the model part number(s) may be defined to create the bill of material. BOM viewing may also be restricted to certain users. The level of BOM listing (parts listing) may also be defined.

Discounts and prices may also be defined as a condition-action set. Discounts may depend on the quantity ordered, what was ordered versus what the subscriber could fulfill, and the like. Discounts may also be defined as a percentage of the price or by specifying a fix dollar value. Recommended parts or spare parts may also be defined using the condition-action set.

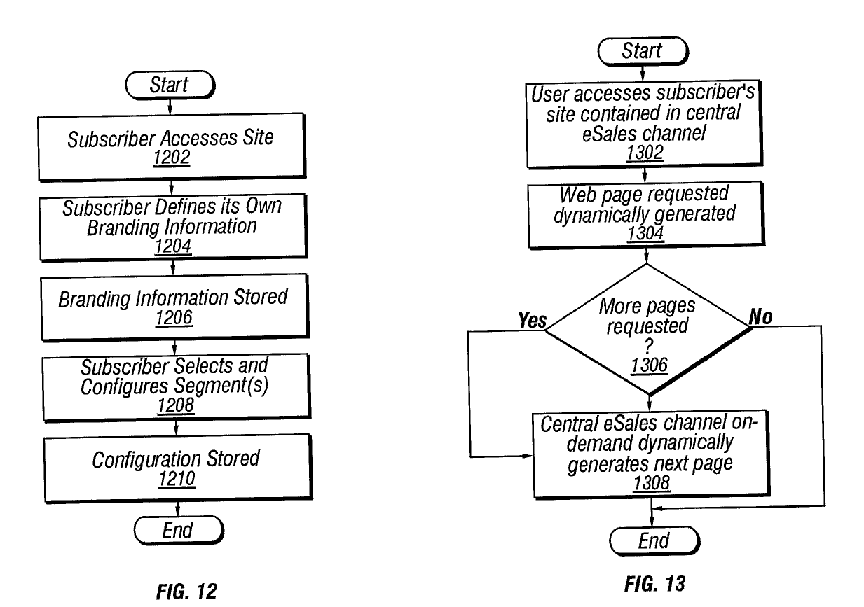

FIG. 12 illustrates a basic block diagram of how a subscriber online and in real-time creates a customized and branded Web site in accordance with the present invention. In the first operation 1202, using the administration application 104 (FIG. 1), the subscriber 110 accesses the administration site of the central e-commerce channel 102. This may be done via a browser 112 using the data network 120. In the next operation 1204, the subscriber defines its own branding information using GUIs, e.g., FIGS. 2 and 3. Security may be enforced by requiring the subscriber to enter the proper login name and password. Branding information defined by the subscriber is then stored 1206 in a data store of the central e-commerce channel 102. This branding information 107 (FIG. 1) may be stored within file systems, such as in text files, or in other forms, such as in a RDBMS. The subscriber then selects and configures segments 1208. This involves selecting, identifying, and defining the segments, products, models, rules, constraints, recommendations, and the like for that particular subscriber. The configuration information obtained from the previous operation 1208 is then stored 1210 in the data store of the central e-commerce channel 102. Similar to branding information, they may be stored as flat files, within database management systems, and the like.

Additional data on segment, product, model, parts, and the like (i.e., configuration information) may also be bulk uploaded to the central e-commerce channel 102 using a bulk upload tool. Such bulk upload then populates the proper data store, including the appropriate data structure. Alternatively, as shown above, they may be entered through the administration application 104. Updates to data 107 (FIG. 1) may also be done using the same administration application 104.

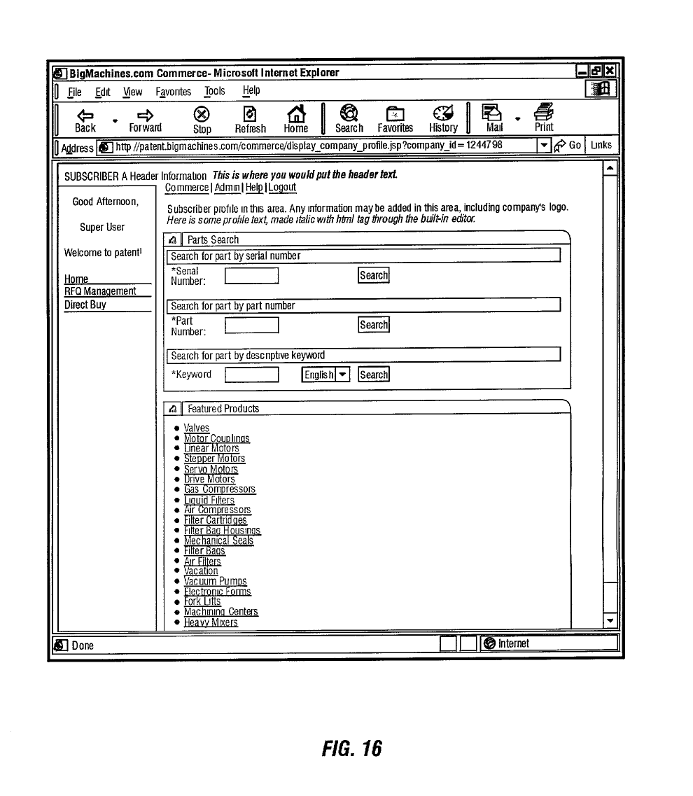

Once the subscriber has provided the appropriate data 107 (this may depend on the business service), users may then access the subscriber's site. FIG. 13 is a basic block diagram of how a user accesses a subscriber's Web site. In the first operation 1302, a user accesses the subscriber's site contained in the central e-commerce channel 102, for example, by typing in a URL, e.g., “subscriberA.cec102.com.” In one embodiment, no Web pages, such as HTML pages, are stored in the central e-commerce channel 102. Rather, the on-demand site application 106 dynamically generates each Web page upon request (considering the branding information) and sends such page to the user 114 via the browser 116. For example, a user may enter the commerce section of the subscriber's site and perform searches based on attributes, keywords, and the like (see FIG. 16). Based on the branding information supplied by the subscriber, particularly the flow, the on-demand site application 106 knows what Web pages are to be presented to the user and in what order.

Referring back to FIG. 13, retrieving data information 107, the on-demand site application 106 dynamically generates a Web page that is sent to the user 1304. If the user requests more Web pages, such as by selecting a hyperlink, a “yes” outcome at decision box 1306, the central e-commerce channel 102, particularly the on-demand site application 106, dynamically generates the requested Web pages. Data 107 stored in the central e-commerce channel 102 may be updated accordingly depending on the user's inputs and actions. If the user, for example, places an order, the process engine 105 accordingly updates the data 107 in the central e-commerce channel 102, if appropriate.

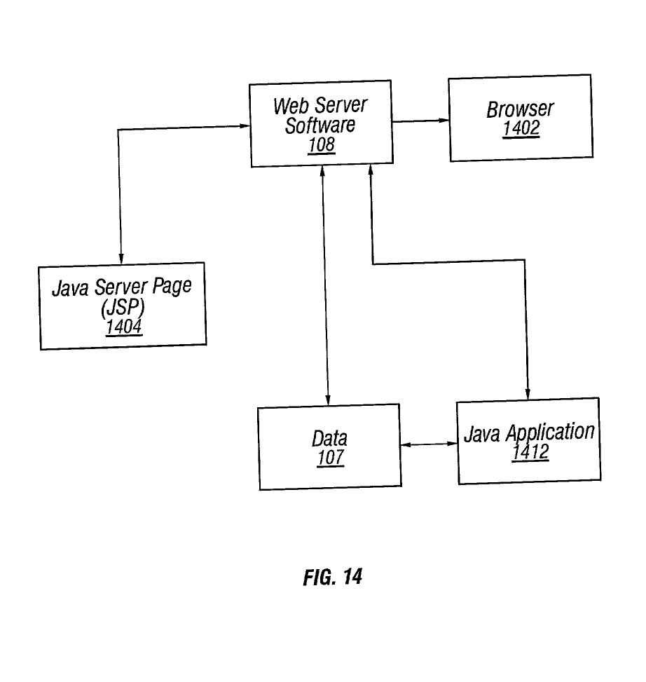

Referring to FIG. 14, the features of the present invention may be implemented in a number of ways. One embodiment may supply the features by using JavaScript, Java, and Java Server Pages technology. Java Server Pages (JSPs) 1404 are stored in the central e-commerce channel 102. These JSPs are written so they will dynamically-generate Web pages, such as HTML file, XML file, XSL file, and the like. They may also be written to implement the business services, e.g., order entry, RFP, and the like, hosted by the central e-commerce channel 102. Once a page request is received, which is typically a request for a JSP page, e.g., the following URL:

“http:H//subscriberA.cec102.com/company_profile.jsp?company_id=16141,” the Web server software 108 reads the requested JSP 1404. In this example, the subscriber is Subscriber A and the network facility provider is at the “cec102.com” domain. Depending on the code written in the JSP 1404, the Web server software 108 may retrieve data 107. The JSP may also call a Java application 1412, which may also accordingly retrieve and process data 107. Outputs of the Java application 1412 and the JSP 1404 are then used by the Web server software 108 to generate a Web page, e.g., an HTML file with Java Scripts, that is sent to the browser 1402, either to the user or subscriber depending on the requested JSP.

To facilitate flexibility within the e-commerce system 100 (FIG. 1), the JSPs within the e-commerce Software 103 are typically coded as a template. Subscriber information, e.g., branding and configuration information, is typically written as an “include” statement (i.e., Java include) or as logical programming code, e.g., if-then-else, as appropriate. By having the JSP written in a template format, the same JSP, for example, that displays model listing with a certain layout, may be used for all subscribers. A JSP for each subscriber need not be coded or written.

With regard to flow, a site is typically divided into several sections, for example, home page, segment listing, product listing, and the like. FIGS. 4a-4c represent the model listing section. Each section has its own set of JSPs to represent the various predefined page templates available for the subscriber to select. A default predefined page template may also be designated. A subscriber may then choose to customize any or all of these sections. Generally, any given JSP represents a single Web page. All JSPs within a section serve the same function in the Web site, thus, information being presented, although in various formats and layout is substantially the same. Each JSP has the same input parameters and passes the same set of parameters, depending on the link it follows. For example, “model_list_{—}1.jsp” represents the JSP for the predefined page template shown in FIG. 4a; “model_list_{—}2.jsp” represents FIG. 4b. Considering that both these predefined page templates are part of model listing section, the expected input and output parameters are the same. Depending also on the flow selected, the appropriate JSPs are modified to link to the correct associated pages. The trails on the pages are also accordingly modified and the cancel buttons, for example, are updated to point to the correct pages for the selected flow.

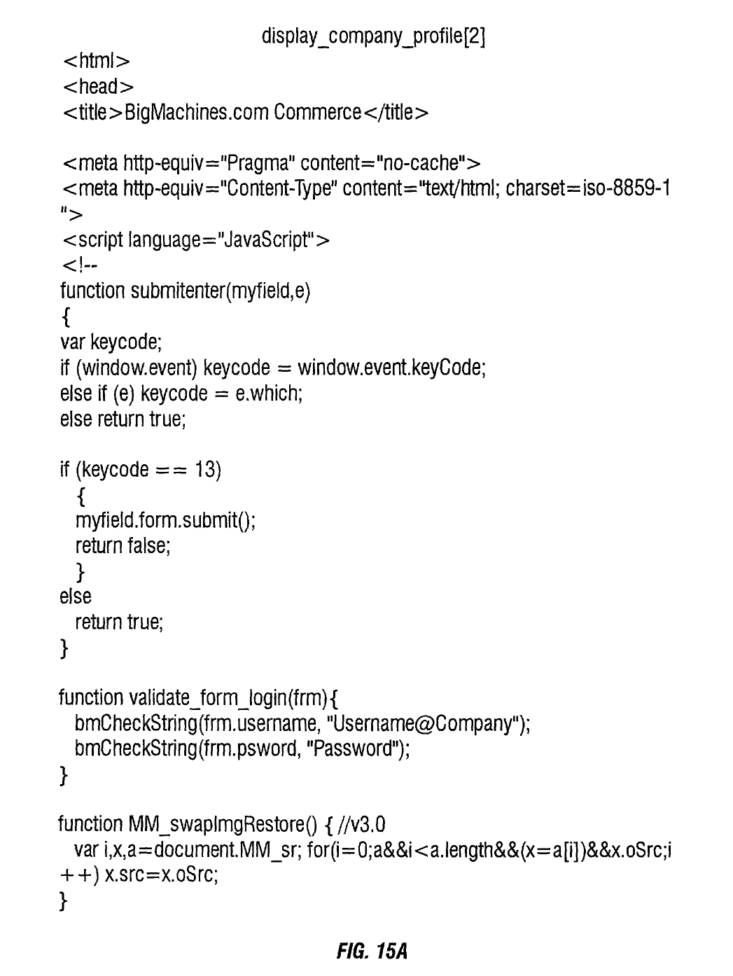

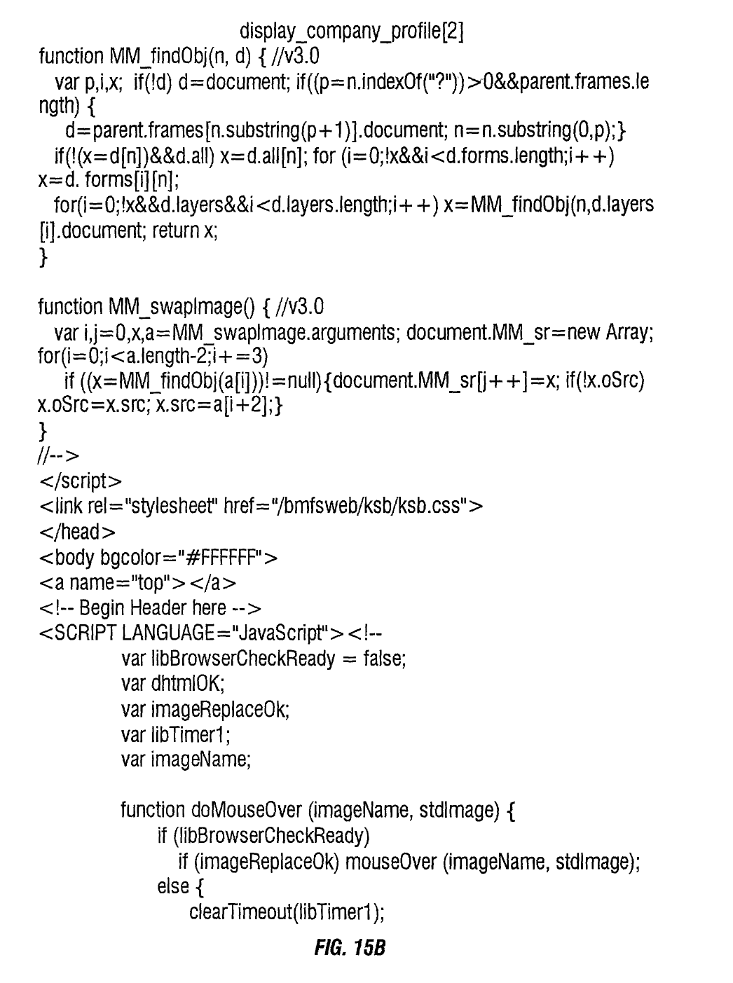

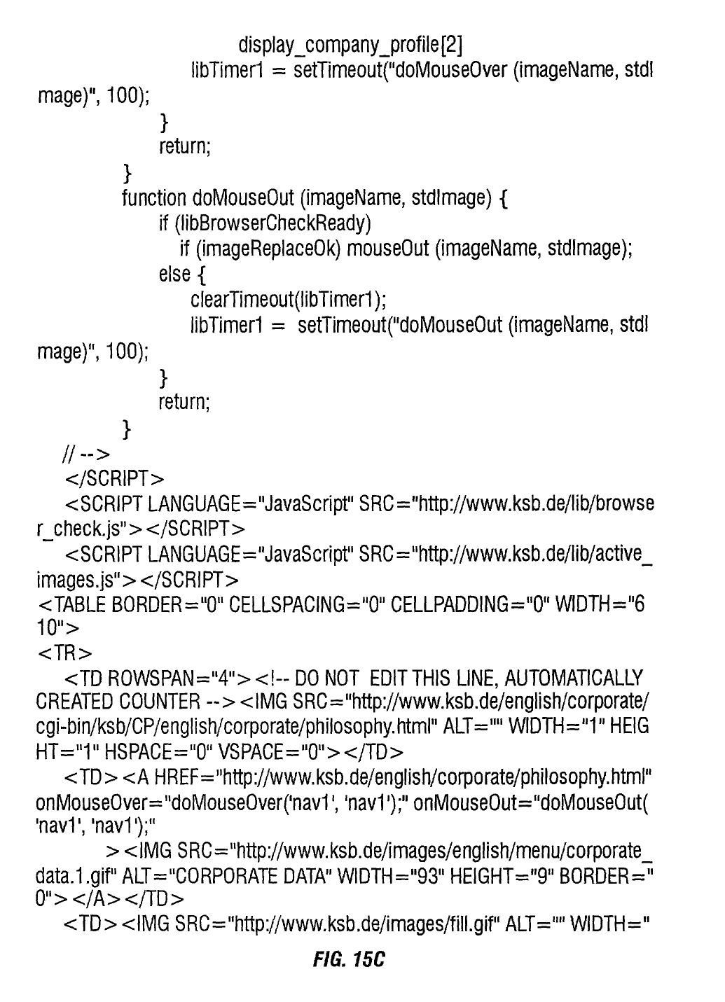

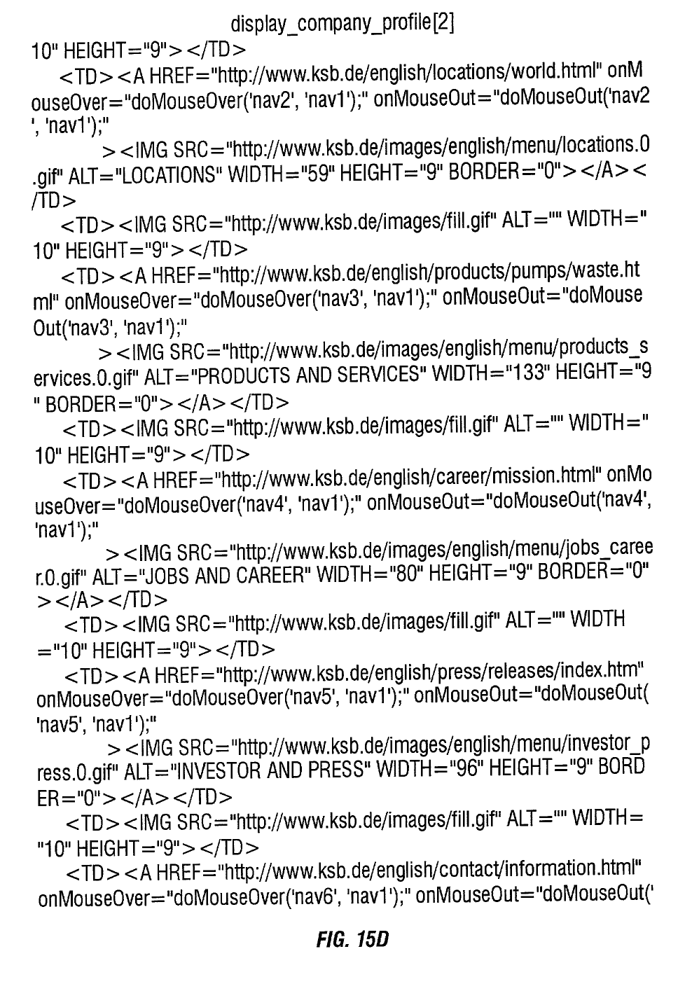

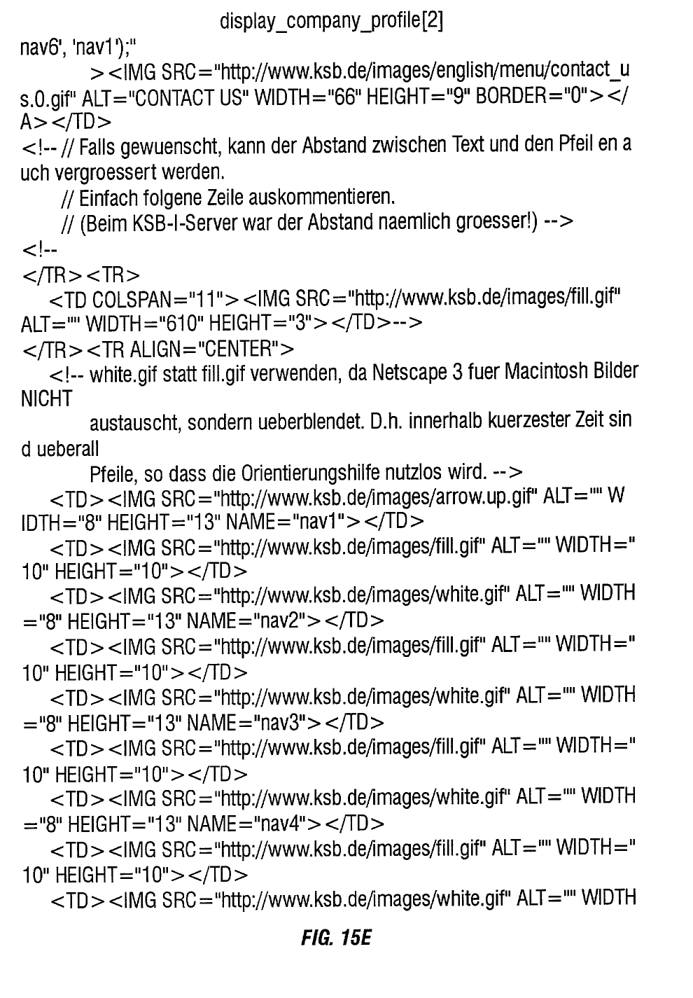

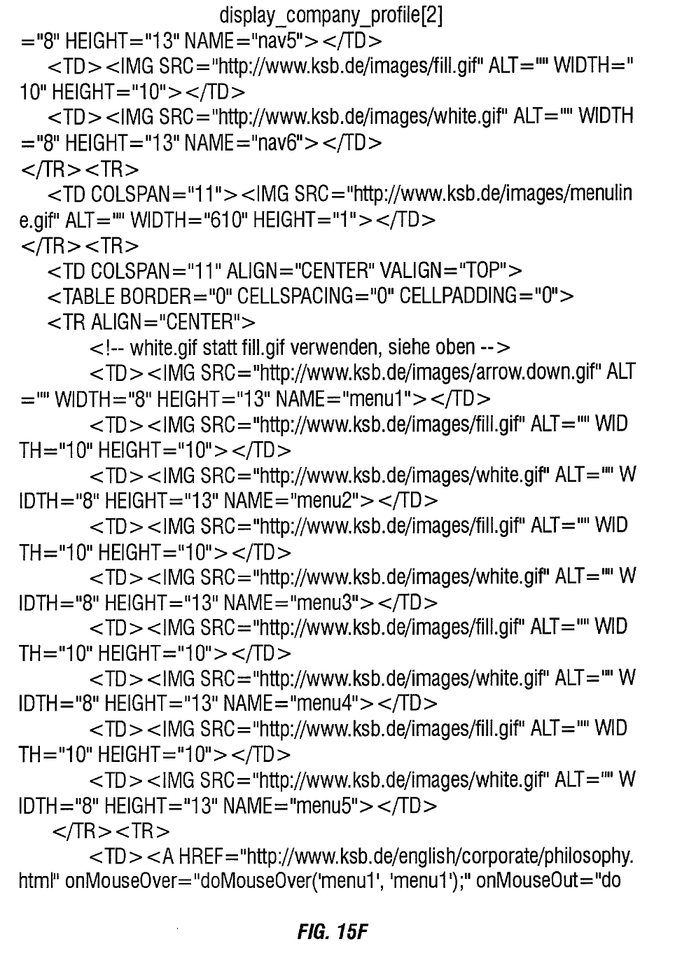

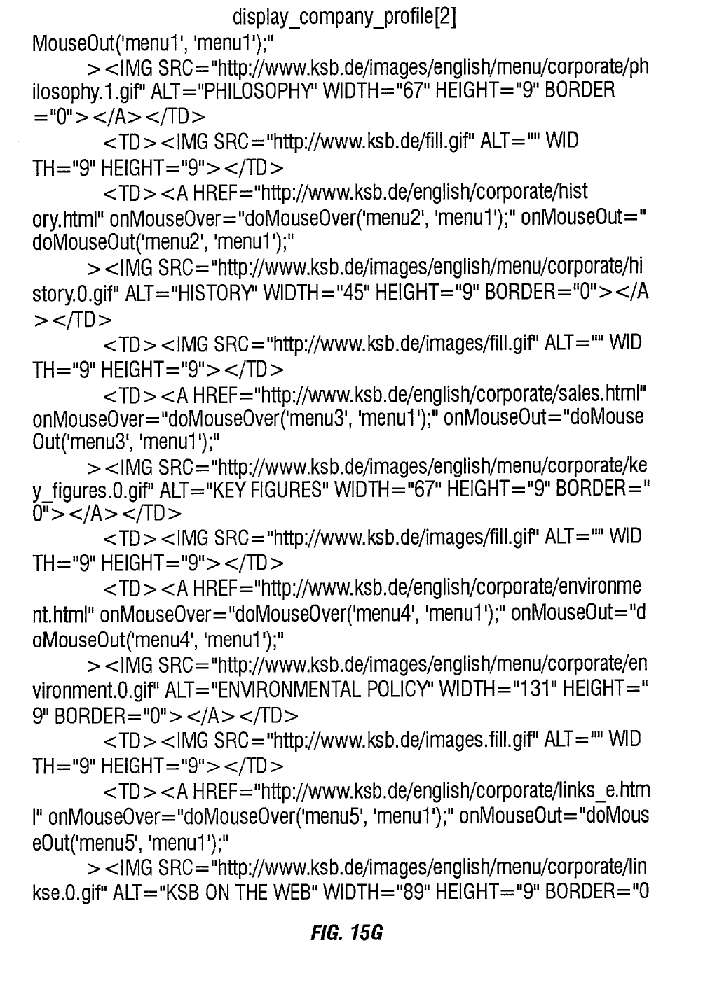

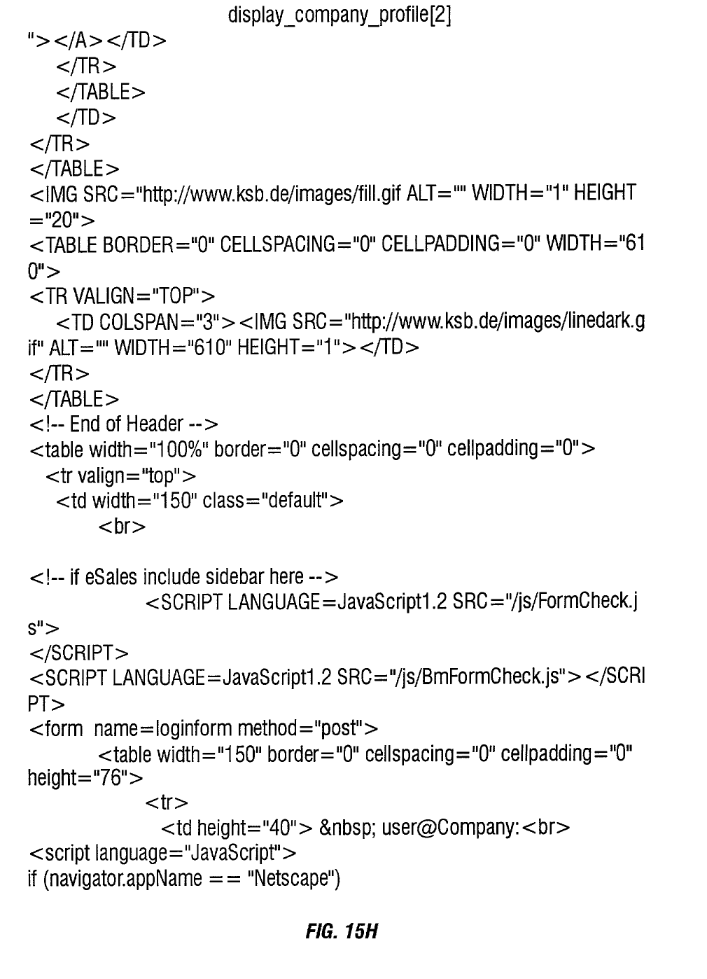

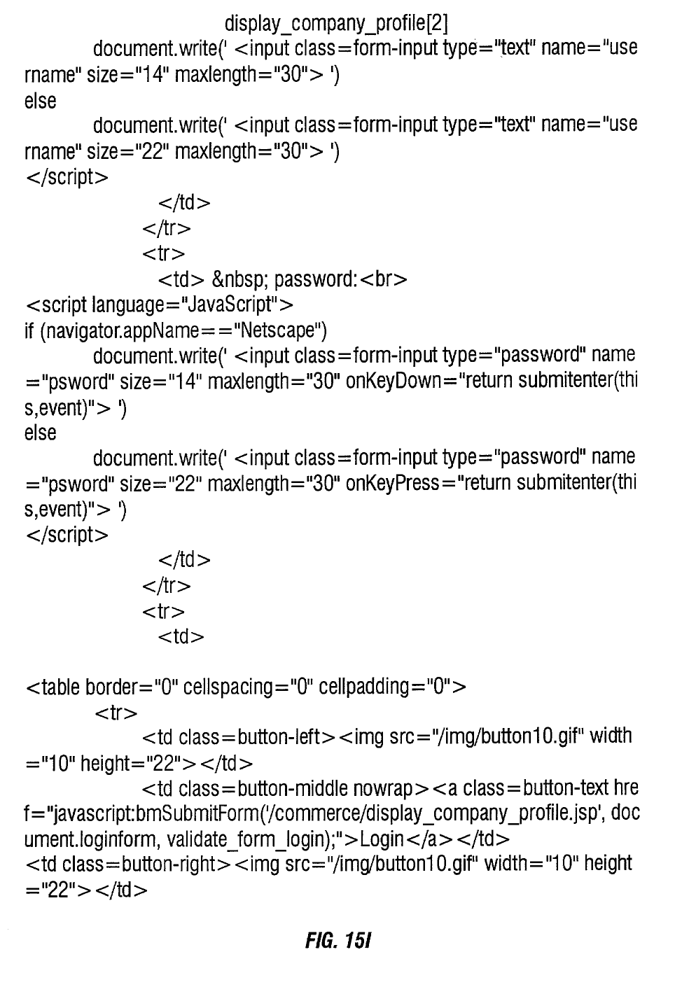

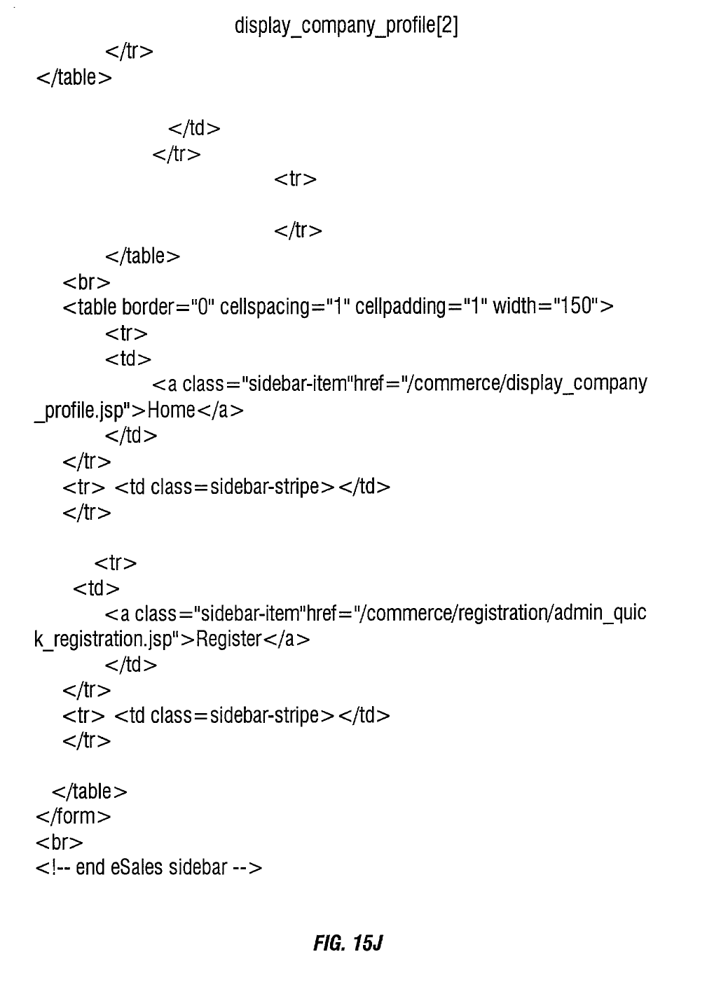

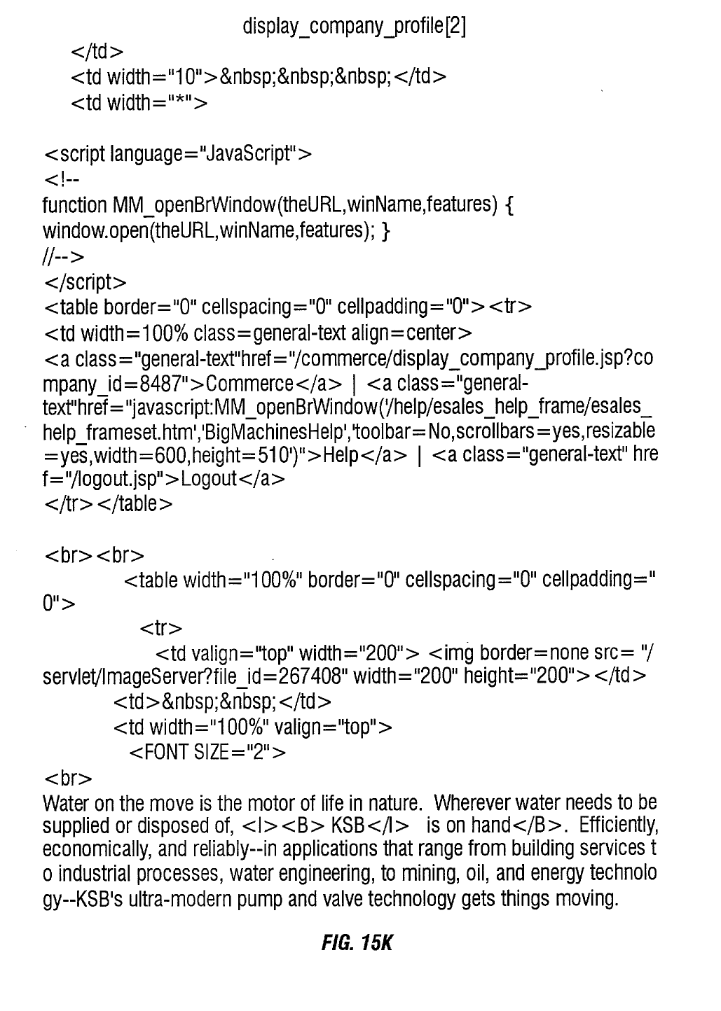

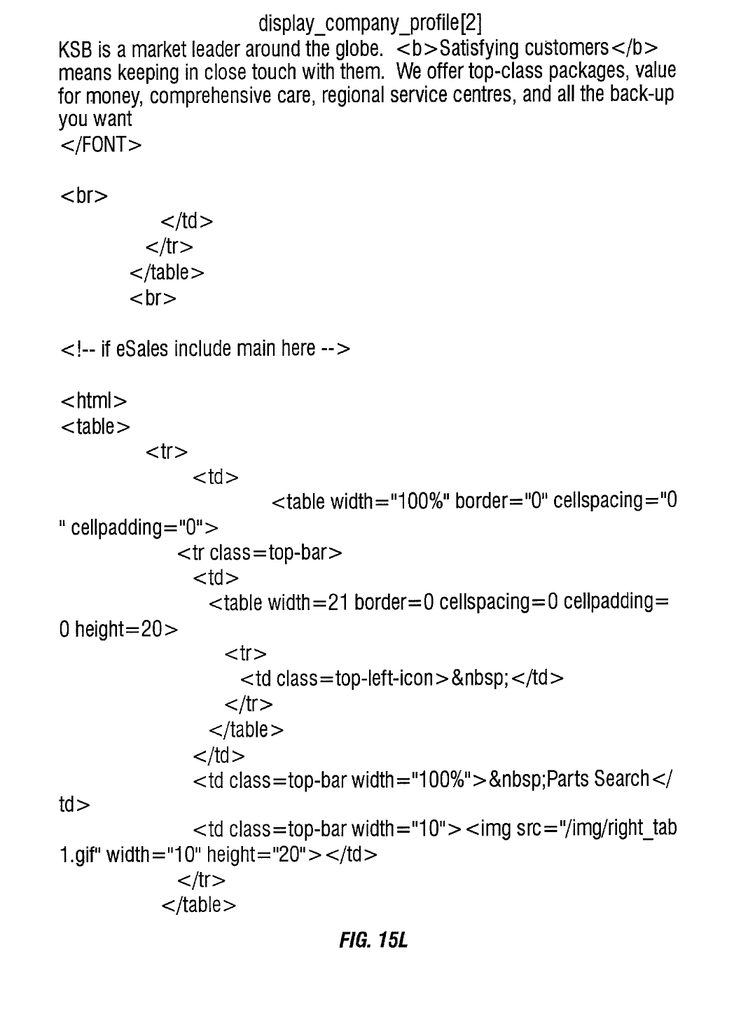

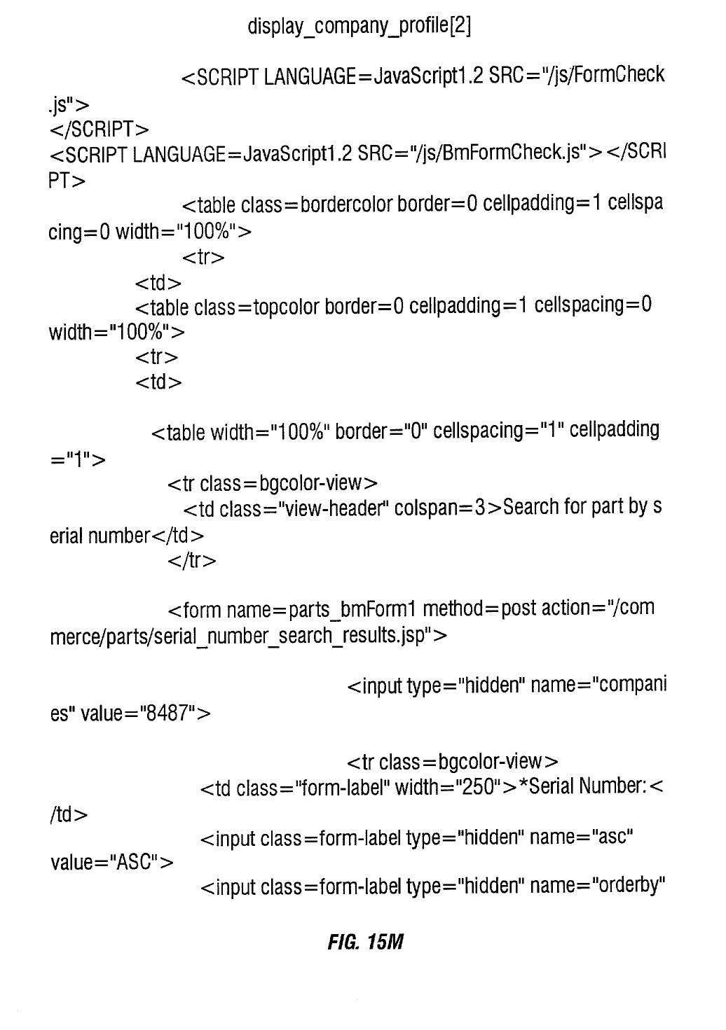

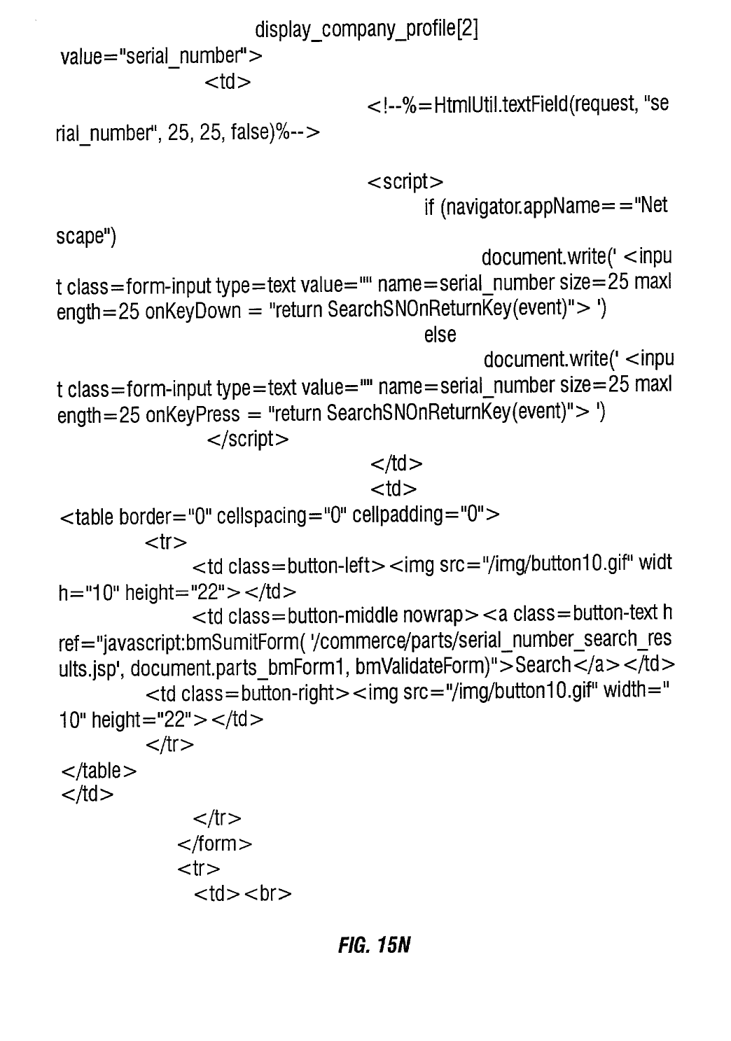

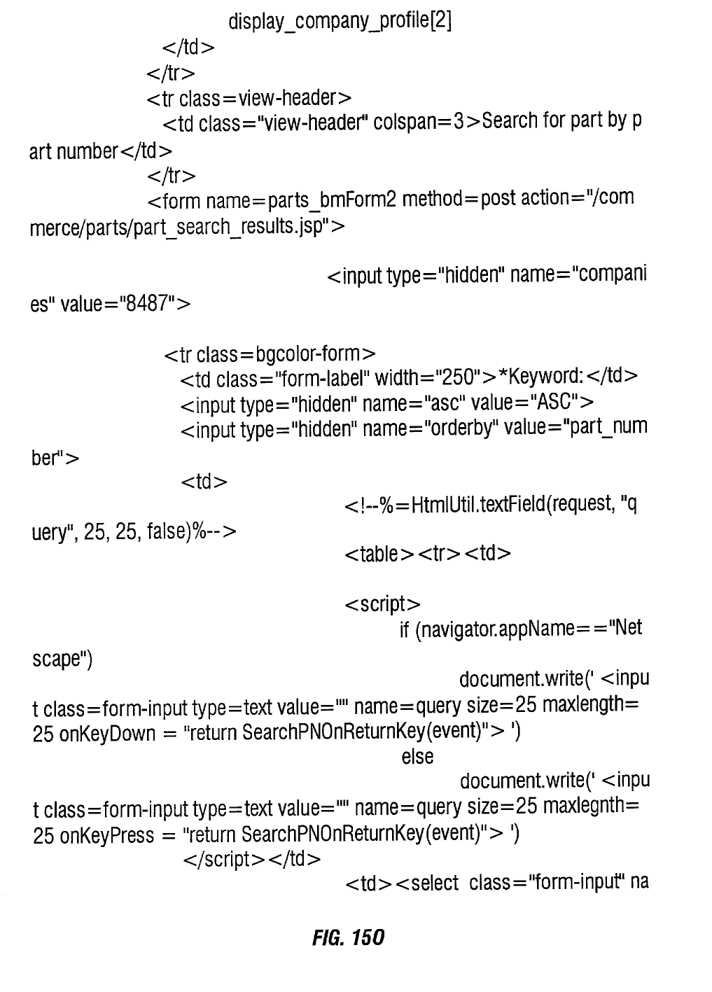

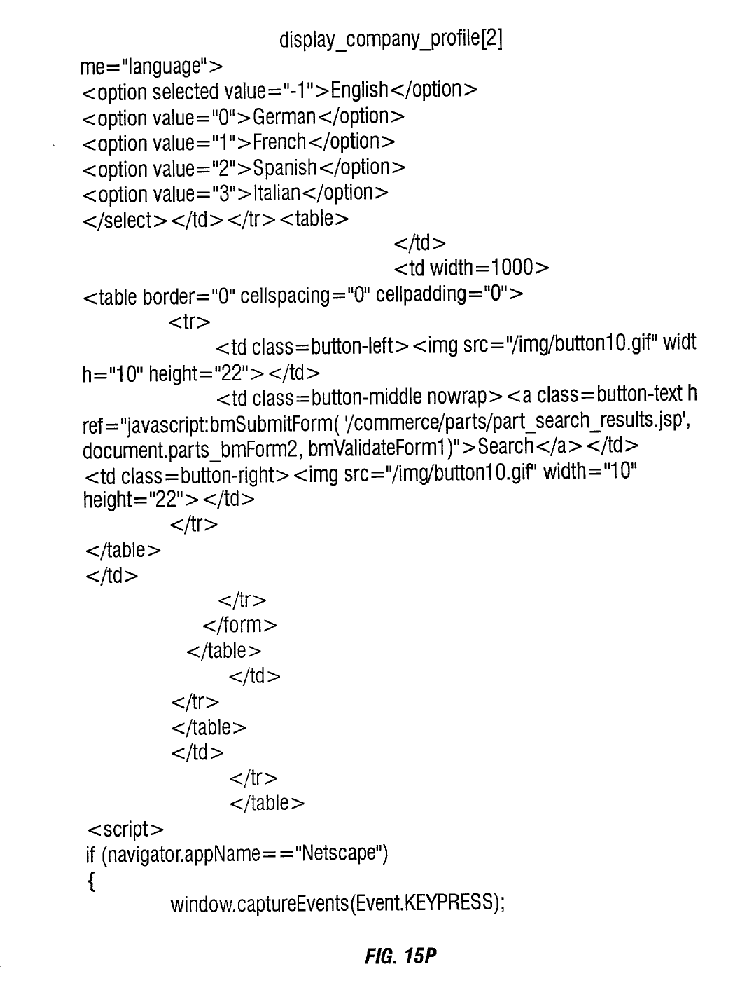

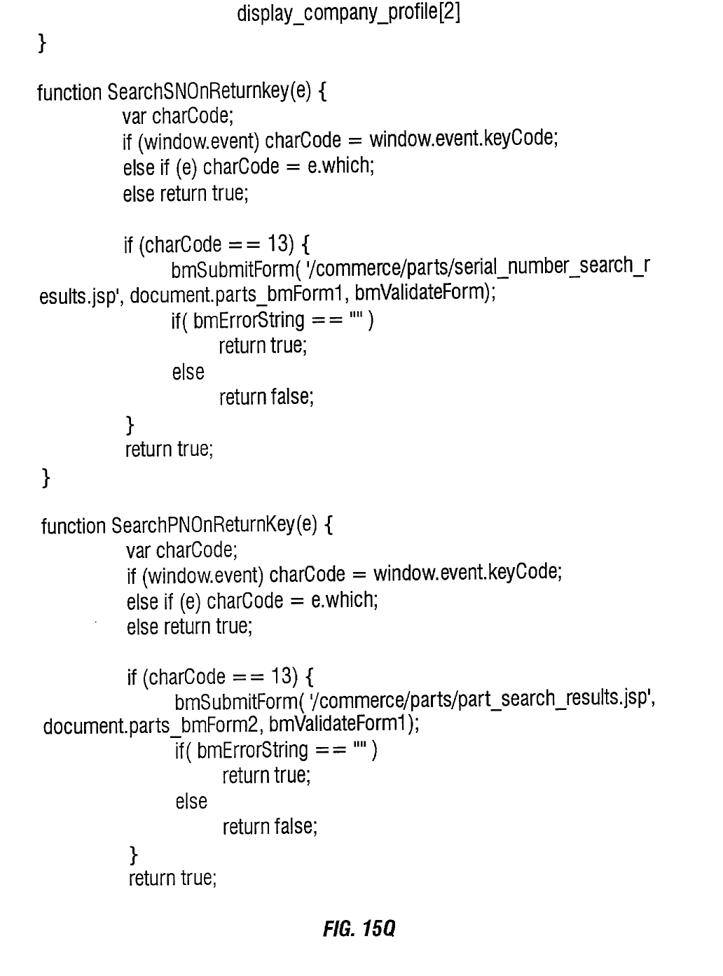

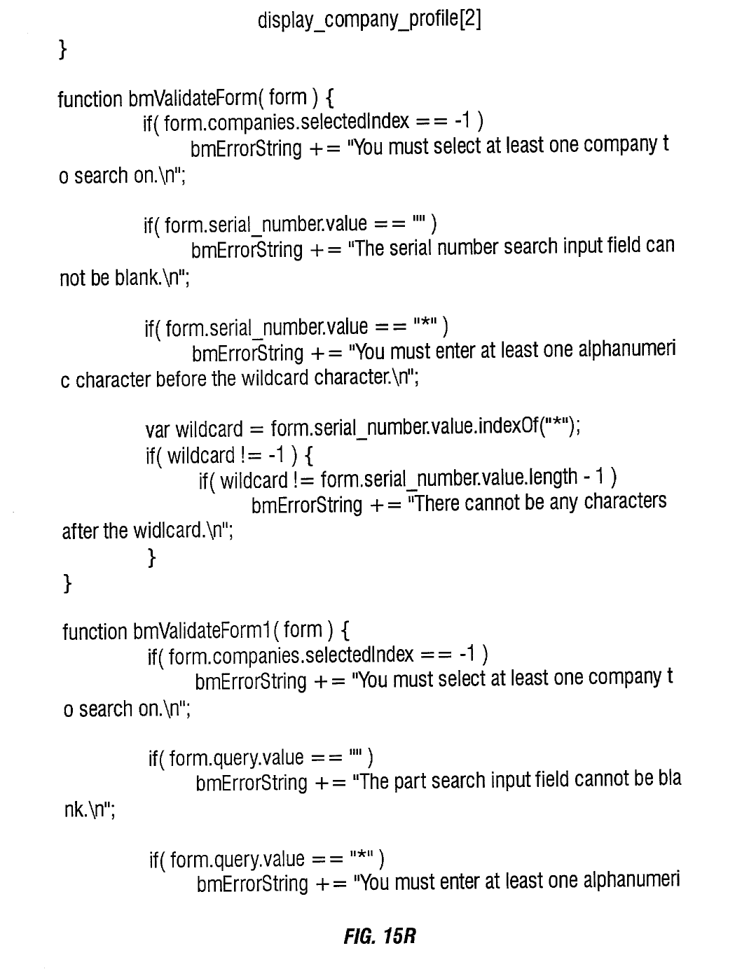

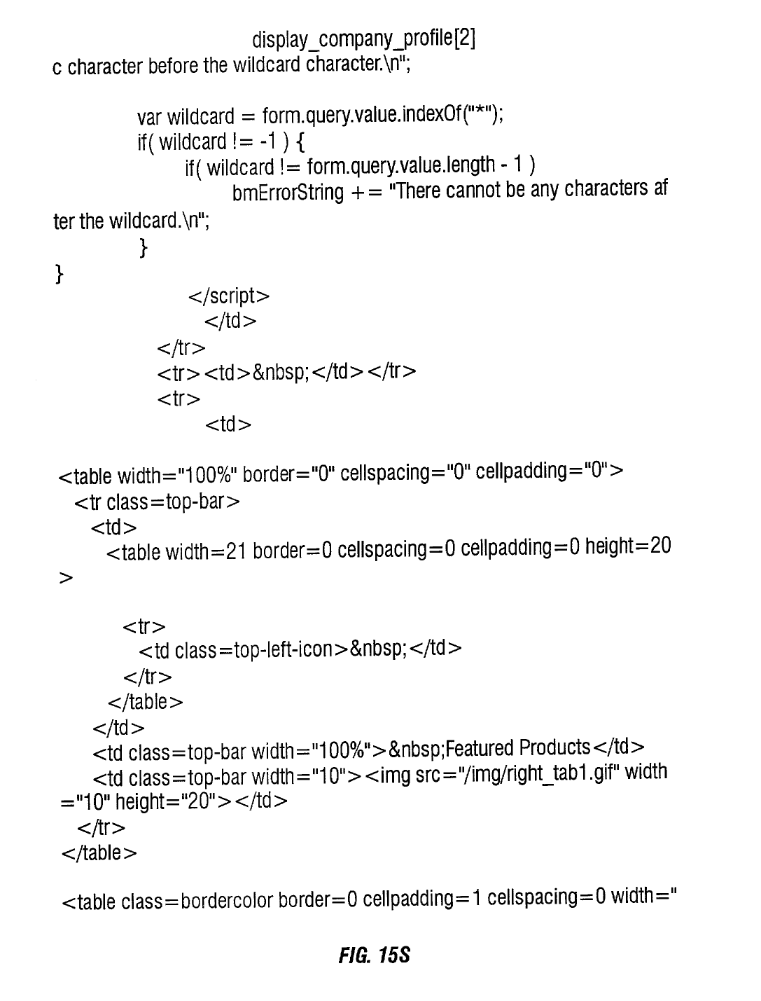

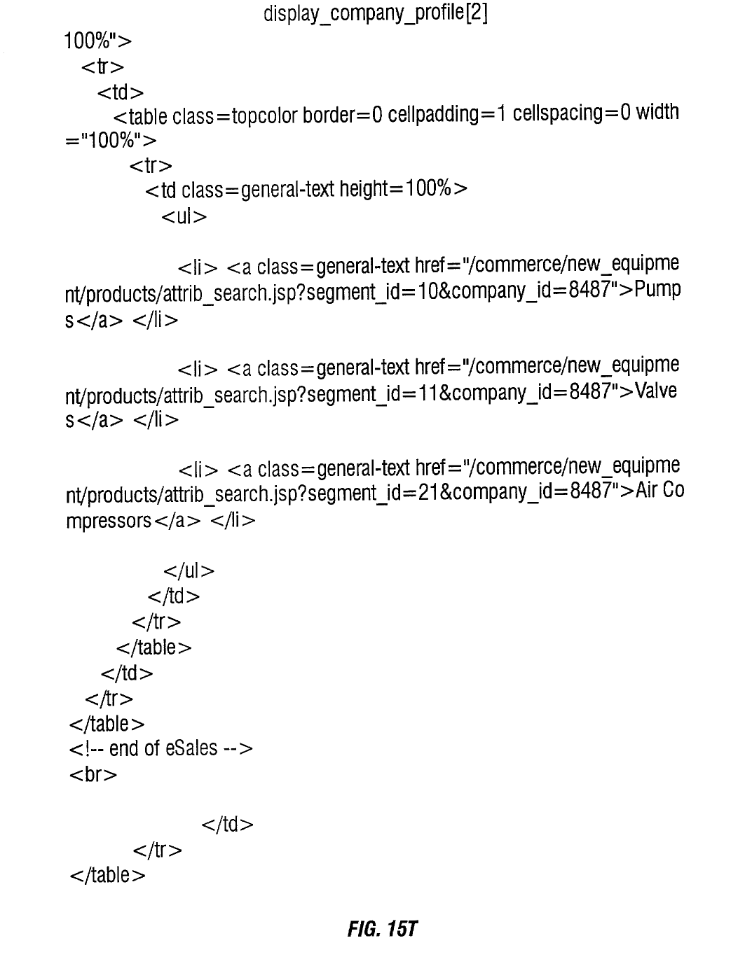

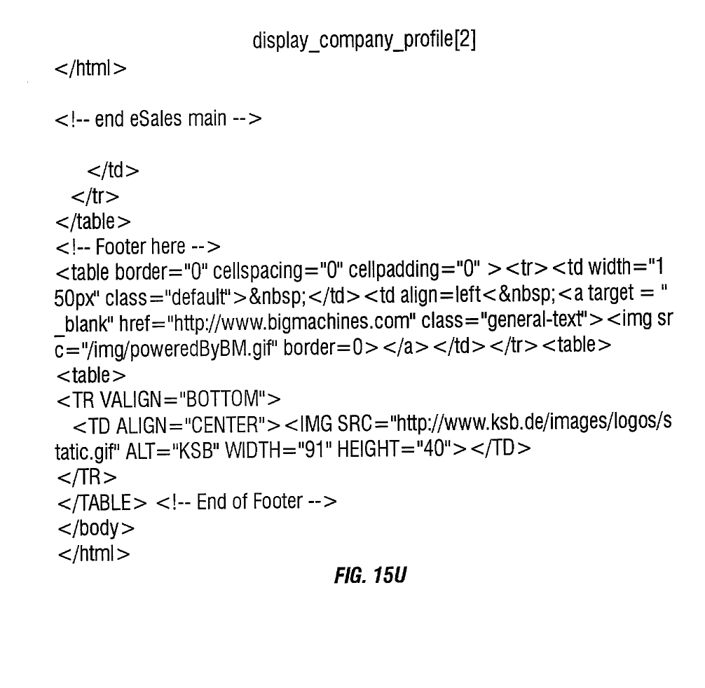

FIGS. 15a-15q illustrate a sample HTML file generated using one of the JSPs constructed in accordance with the present invention.

III. Central e-Commerce Channel

The central e-commerce channel 102 has also its built-in administration tool called commerce administration tool 109 (FIG. 1), which facilitates the operation of the e-commerce system 100. The tool 109 may have GUIs which enables administrators of the central e-commerce channel 102 to easily add subscribers, reset passwords, create specific directories for each subscriber, and the like.

The commerce administration tool 109 also has a breadth tool. This facilitates the creation and maintenance of new and existing segments. A set of GUIs is presented to the administrator, optionally to the subscribers, enabling them to define new segments. Once a new segment is defined and made available to subscribers, subscribers may select and configure the new segment as part of their site. Existing business services implemented by the process engine 105 may immediately use the configured segment. Thus, if a new “used car” segment is defined and configured by a subscriber, users of that subscriber's Web site may immediately place orders (assuming order entry is part of the process engine 105) for that subscriber.

In one embodiment, the breadth tool is written as a set of JSPs with JAVA classes. Using this set of JSPs (herein called breadth tool JSPs), another set of JSPs are automatically generated (herein called segment JSPs), whenever a segment is created or updated. The segment JSPs are the ones requested by the users. This breadth tool enables subscribers to create their own custom segments. Once created, they are immediately available to the subscriber to configure and make part of their site. The subscriber's site need not be shut down to implement a new segment.

FIG. 16 is an exemplary GUI that is seen by a user accessing a subscriber's Web site. Depending on the services subscribed to, the business services available will vary.

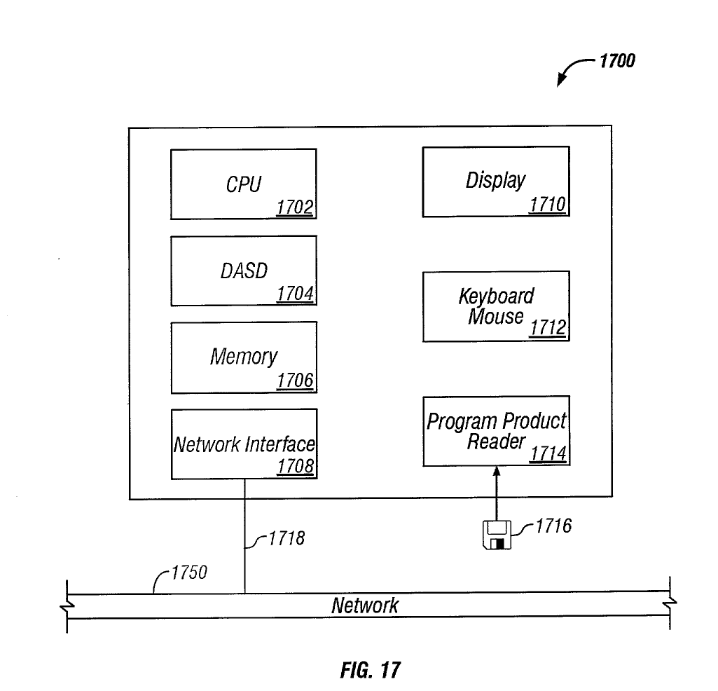

FIG. 17 is a block diagram of an exemplary computer 1700 such as might comprise any of the servers or computers in FIG. 1. Each computer 1700 operates under control of a central processor unit (CPU) 1702, such as a “Pentium” microprocessor and associated integrated circuit chips, available from Intel Corporation of Santa Clara, Calif., USA. A computer user can input commands and data from a keyboard and mouse 1712 and can view inputs and computer output at a display 1710. The display is typically a video monitor or flat panel display device. The computer 1700 also includes a direct access storage device (DASD) 1704, such as a fixed hard disk drive. The memory 1706 typically comprises volatile semiconductor random access memory (RAM). Each computer preferably includes a program product reader 1714 that accepts a program product storage device 1716, from which the program product reader can read data (and to which it can optionally write data). The program product reader can comprise, for example, a disk drive, and the program product storage device can comprise removable storage media such as a floppy disk, an optical CD-ROM disc, a CD-R disc, a CD-RW disc, DVD disc, or the like. Each computer 1700 can communicate with the other connected computers over the network 1750 through a network interface 1708 that enables communication over a connection 1718 between the network and the computer.

The CPU 1702 operates under control of programming steps that are temporarily stored in the memory 1706 of the computer 1700. When the programming steps are executed, the pertinent system component performs its functions. Thus, the programming steps implement the features of the invention. The programming steps can be received from the DASD 1704, through the program product 1716, or through the network connection 1718. The storage drive 1704 can receive a program product, read programming steps recorded thereon, and transfer the programming steps into the memory 1706 for execution by the CPU 1702. As noted above, the program product storage device can comprise any one of multiple removable media having recorded computer-readable instructions, including magnetic floppy disks, CD-ROM, and DVD storage discs. Other suitable program product storage devices can include magnetic tape and semiconductor memory chips. In this way, the processing steps necessary for operation in accordance with the invention can be embodied on a program product.

Alternatively, the program steps can be received into the operating memory 1706 over the network 1718. In the network method, the computer receives data including program steps into the memory 1706 through the network interface 1708 after network communication has been established over the network connection 1718 by well-known methods that will be understood by those skilled in the art without further explanation. The program steps are then executed by the CPU 1702 to implement the processing and features of the present invention.

It should be understood that all of the computers of the system, illustrated in FIG. 1, preferably have a construction similar to that shown in FIG. 17, so that details described with respect to the FIG. 17 computer 1700 will be understood to apply to all computers of the system in FIG. 1. Any of the computers can have an alternative construction, so long as they can support the functionality described herein. For example, the central e-commerce channel 102 may be deployed on one or more servers.

One skilled in the art will recognize that variations in the steps, as well as the order of execution, may be done and still make the invention operate in accordance with the features of the invention. Variations on how information is received by the e-commerce channel such as via voice recognition, touch screen, and the like are also covered.

The present invention has been described above in terms of a presently preferred embodiment so that an understanding of the present invention can be conveyed. There are, however, many configurations for an e-commerce system not specifically described herein but with which the present invention is applicable. e.g., e-commerce system using wireless networks, devices, and technologies. The present invention should therefore not be seen as limited to the particular embodiments described herein, but rather, it should be understood that the present invention has wide applicability with respect to e-commerce systems generally. All modifications, variations, or equivalent arrangements and implementations that are within the scope of the attached claims should therefore be considered within the scope of the invention.

We claim:

1. A method of Web site processing, comprising:
receiving branding information;
receiving configuration information whereby such configuration information includes selection and definition of one or more segments, products, and models; and
storing said branding information and said configuration information in a data store.

2. A method of processing at a network location, the method comprising:
receiving branding information for a subscriber network site;
receiving configuration information from a subscriber, wherein the configuration information specifies a selection from among a plurality of predetermined flow sequences of linked pages;
storing the branding information and configuration information such that the branding information and configuration information may be retrieved in response to a request for a page of the subscriber network site to dynamically generate a corresponding page of the subscriber network site.

3. A method as defined in claim 2, wherein each predetermined flow sequence defines alternative hierarchical arrangements of linked pages.

4. A method as defined in claim 3, wherein a set of attributes further define contents of linked pages at each level of the hierarchy.

5. A method as defined in claim 4, wherein the attributes can be searched by the network user.

6. A method as defined in claim 3, further including:
receiving a request from a network user at a host site for a page of the subscriber network site;
transmitting a dynamically generated page from the host site to the network user comprising a page corresponding to the requested subscriber network site page.

7. A method as defined in claim 6, wherein the alternative hierarchical arrangements of the predetermined flow sequences include market segments, product lines, and configurable models offered by the subscriber.

8. A method as defined in claim 6, wherein the market segments comprise different network address domains hosted at the network host site, and the subscriber network site comprises a sub-domain of the network host site.

9. A method as defined in claim 6, wherein the alternative hierarchical arrangements of linked pages are defined by linked template pages specified by a scripting language.

10. A method as defined in claim 9, wherein the scripting language implements Java Server Pages.

11. A method as defined in claim 3, wherein receiving configuration information comprises receiving information relating to product lines offered by the subscriber.

12. A method as defined in claim 3, wherein receiving configuration information comprises receiving information relating to configurable models offered by the subscriber.

13. A method as defined in claim 3, wherein the pages are dynamically generated by a server process of the network location.

14. A method as defined in claim 3, wherein the page arrangements are defined by a template page in a scripting language.

15. A method as defined in claim 12, wherein the scripting language implements Java Server Pages.

16. A network server comprising:
a server that receives branding 'information for a subscriber network site and receives configuration information from a subscriber, wherein the configuration information specifies a selection from among a plurality of predetermined flow sequences of linked pages;
a data store in which the branding information and configuration information is stored, such that the branding information and configuration information may be retrieved by the server in response to a request for a page of the subscriber network site to dynamically generate a corresponding page of the subscriber network site.

17. A network server as defined in claim 16, wherein each predetermined flow sequence defines alternative hierarchical arrangements of linked pages.

18. A network server as defined in claim 17, wherein a set of attributes further define contents of linked pages at each level of the hierarchy.

19. A network server as defined in claim 18, wherein the attributes can be searched by the network user.

20. A network server as defined in claim 17, wherein the server further receives a request from a network user at a host site for a page of the subscriber network site and transmits a dynamically generated page from the host site to the network user comprising a page corresponding to the requested subscriber network site page.

21. A network server as defined in claim 20, wherein the alternative hierarchical arrangements of the predetermined flow sequences include market segments, product lines, and configurable models offered by the subscriber.

22. A network server as defined in claim 20, wherein the market segments comprise different network address domains hosted at the network host site, and the subscriber network site comprises a sub-domain of the network host site.

23. A network server as defined in claim 20, wherein the alternative hierarchical arrangements of linked pages are defined by linked template pages specified by a scripting language.

24. A network server as defined in claim 23, wherein the scripting language implements Java Server Pages.

25. A network server as defined in claim 17, wherein receiving configuration information comprises receiving information relating to product lines offered by the subscriber.

26. A network server as defined in claim 17, wherein receiving configuration information comprises receiving information relating to configurable models offered by the subscriber.

27. A network server as defined in claim 17, wherein the pages are dynamically generated by a server process of the network location.

28. A network server as defined in claim 17, wherein the page arrangements are defined by a template page in a scripting language.

29. A network server as defined in claim 26, wherein the scripting language implements Java Server Pages.

30. A system that provides dynamic branding for a computer network site that produces display pages, the system comprising:
a data store of the computer network, at which data for the computer network site is stored;
processing means for receiving branding information for the computer network site and for receiving site configuration information from a subscriber, wherein the configuration information specifies a selection from among a plurality of predetermined flow sequences of linked pages for the site; and
server means for dynamically generating a page of the subscriber site in response to a user request for the page, wherein the generated page is generated in accordance with the branding information and configuration information.

31. A system as defined in claim 30, wherein each predetermined flow sequence defines alternative hierarchical arrangements of linked pages.

32. A system as defined in claim 31, wherein the page arrangements are defined by a template page in a scripting language.

33. A system as defined in claim 30, wherein the configuration information received by the processing means comprises information relating to product lines offered by the subscriber.

34. A system as defined in claim 30, wherein the configuration information received by the processing means comprises information relating to configurable models offered by the subscriber.
